(19) United States
(12) Patent Application Publication
(10) Pub. No.: US 2025/0074229 A1
(43) Pub. Date: Mar. 6, 2025

(54) SYSTEMS AND METHODS FOR ELECTRIC VEHICLE CHARGING

(71) Applicant: ABB E-Mobility B.V., Delft (NL)

(72) Inventor: Stefan Joannes Raaijmakers, Delft (NL)

(21) Appl. No.: 18/817,670

(22) Filed: Aug. 28, 2024

Related U.S. Application Data
(60) Provisional application No. 63/579,186, filed on Aug. 28, 2023.

(51) Int. Cl. B60L 53/30; B60L 53/66

(52) U.S. Cl. CPC B60L 53/305; B60L 53/66

(57) ABSTRACT

A communications interface between electric vehicle supply equipment and an electric vehicle is provided. The communication interface includes a first connection configured to connect to a controller of the electric vehicle supply equipment and a second connection configured to connect to a controller of the electric vehicle. The communication interface further includes a plurality of communication conductors coupled between the first and second connections for communication between the controller of the electric vehicle supply equipment and the controller of the electric vehicle. The controller of the electric vehicle supply equipment is configured to supply power to the controller of the electric vehicle over one or more of the plurality of communication conductors.

### CROSS-REFERENCE TO RELATED APPLICATIONS

This application claims priority to U.S. Provisional Patent Application No. 63/579,186, filed Aug. 28, 2023 and titled “SYSTEM AND METHODS FOR ELECTRIC VEHICLE CHARGING”, the entire contents of which are hereby incorporated by reference.

### BACKGROUND

The field of the disclosure relates to electric vehicles, and more particularly, to interfaces between electric chargers and electric vehicles.

An electric vehicle (EV) is driven by electric motors, which are powered by a rechargeable battery within the EV. As the rechargeable battery has a finite energy storage, the rechargeable battery is typically recharged when the remaining charge falls below a desired charge point. An EV may be recharged using electric vehicle supply equipment (EVSE). Different forms of electric signaling may be used for communication between the EV and EVSE. The signaling implemented to control EV charging does not always yield effective and efficient EV battery charging. With the growing popularity of EVs, known systems and methods are disadvantaged in some aspects in meeting the charging needs of EVs. As a result, improvements to existing charging methods and systems are desired.

### BRIEF DESCRIPTION

In one embodiment, a communications interface between electric vehicle supply equipment and an electric vehicle is provided. The communication interface includes a first connection configured to connect to a controller of the electric vehicle supply equipment and a second connection configured to connect to a controller of the electric vehicle. The communication interface further includes a plurality of communication conductors coupled between the first and second connections for communication between the controller of the electric vehicle supply equipment and the controller of the electric vehicle. The controller of the electric vehicle supply equipment is configured to supply power to the controller of the electric vehicle over one or more of the plurality of communication conductors.

In another embodiment, a communications interface between electric vehicle supply equipment and an electric vehicle is provided. The communication interface includes a first connection configured to connect to a controller of the electric vehicle supply equipment and a second connection configured to connect to a controller of the electric vehicle. The communication interface further includes a plurality of communication conductors coupled between the first and second connections for communication between the controller of the electric vehicle supply equipment and the controller of the electric vehicle. The controller of the electric vehicle is configured to supply power to the controller of the electric vehicle supply equipment over one or more of the plurality of communication conductors.

In another embodiment, circuitry for providing an auxiliary power supply over an insertion detection (ID) line is provided. The circuit includes an e-fuse and a load switch circuit. The load switch circuit is coupled to the e-fuse and to the ID line, and the load switch circuit is configured to supply auxiliary power via the ID line when an ID signal received via the ID line is at least a threshold voltage.

### BRIEF DESCRIPTION OF DRAWINGS

These and other features, aspects, and advantages of the present disclosure will become better understood when the following detailed description is read with reference to the accompanying drawings in which like characters represent like parts throughout the drawings.

FIG. 1 depicts a system for charging an electric vehicle in an exemplary embodiment.

FIGS. 2A-2C depict a schematic diagram of an example circuit board that may be used to control and/or test various communication interfaces.

FIGS. 3A-3F depict a schematic diagram of a switch chip for Fse with the circuit board shown in FIGS. 2A-2C.

FIGS. 4A and 4B depict a schematic diagram of an example microchip for use in the system shown in FIG. 1.

FIGS. 5A-5C depict a schematic diagram of another example microchip for use in the system shown in FIG. 1.

FIGS. 6A-6E depict a schematic diagram of another example microchip for use in the system shown in FIG. 1.

FIGS. 7A-7D depict a schematic diagram of another example microchip for use in the system shown in FIG. 1.

FIGS. 8A-8F depict a schematic diagram of another example microchip for use in the system shown in FIG. 1.

FIGS. 9A-9D depict a schematic diagram of another example microchip for use in the system shown in FIG. 1.

FIGS. 10A and 10B depict a schematic diagram of an example circuit utilizing two microchips such as those shown in FIGS. 4A and 4B in parallel with FIGS. 9A-9D.

FIGS. 11A and 11B depict a schematic diagram of an example circuit for providing power over data line for use in the system shown in FIG. 1.

FIG. 12 depicts a schematic diagram of an example circuit for serving as an interface between electric vehicle supply equipment and an EV such as those shown i.

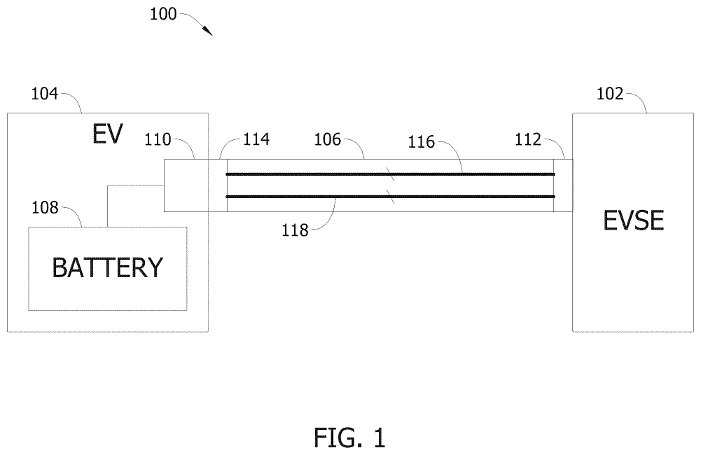

FIG. 1 that illustrates high level communication and low level communication signaling paths.

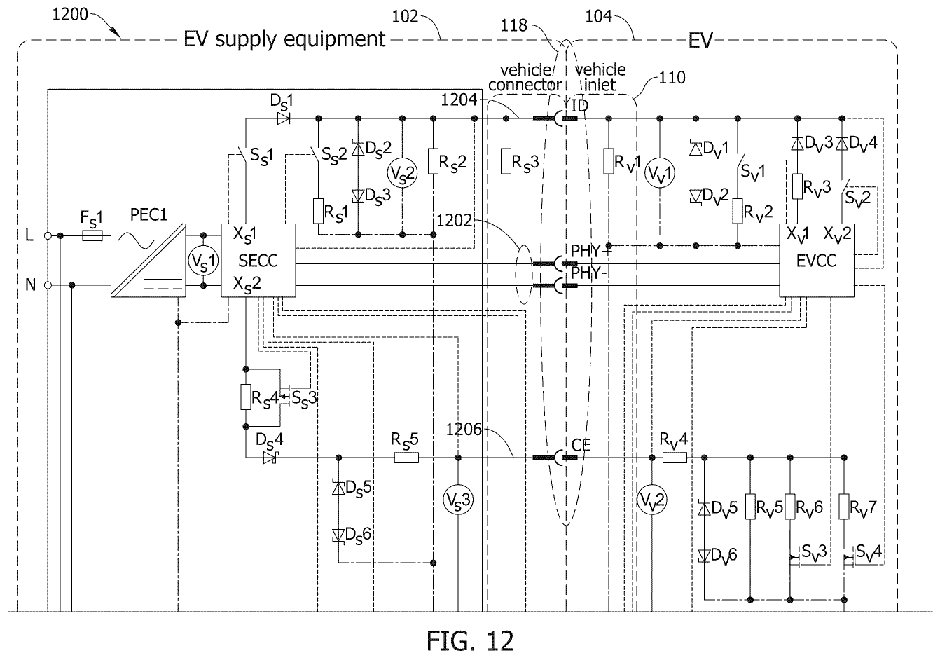

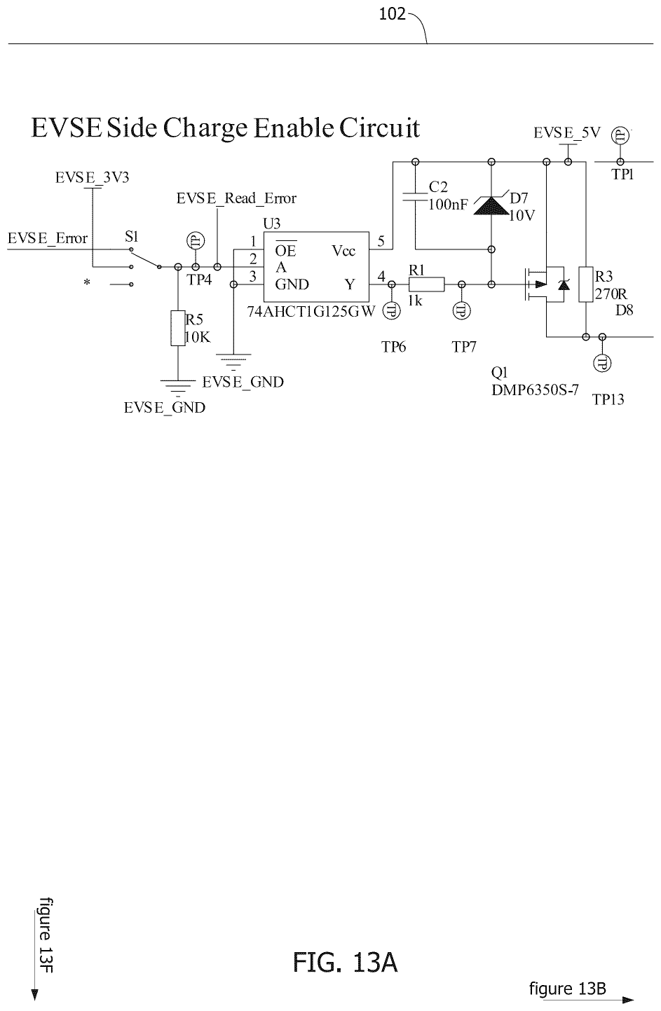

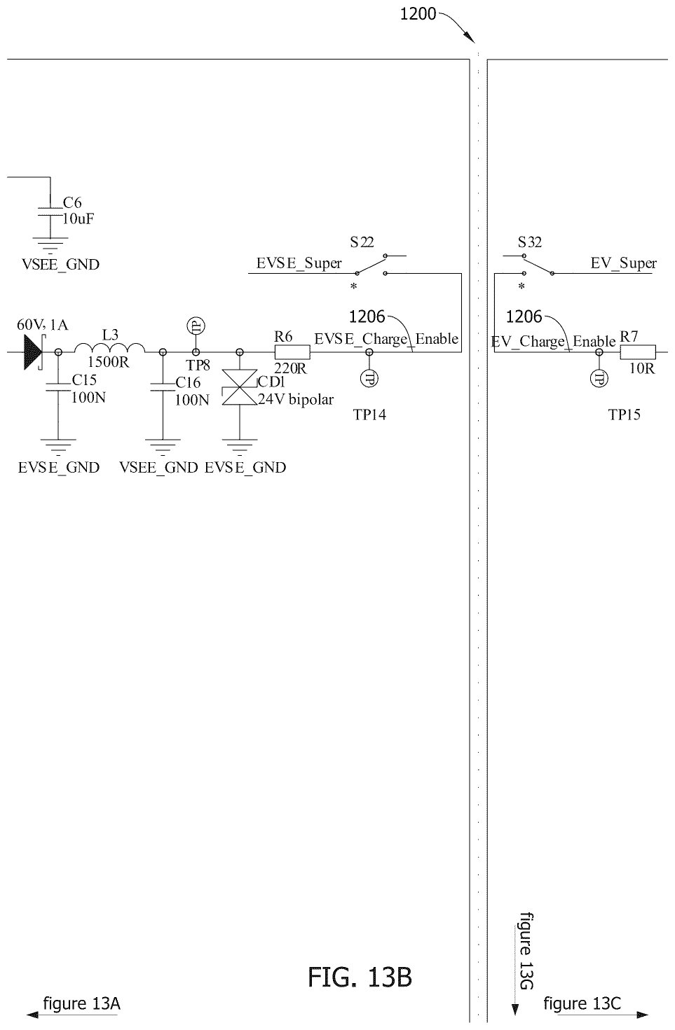

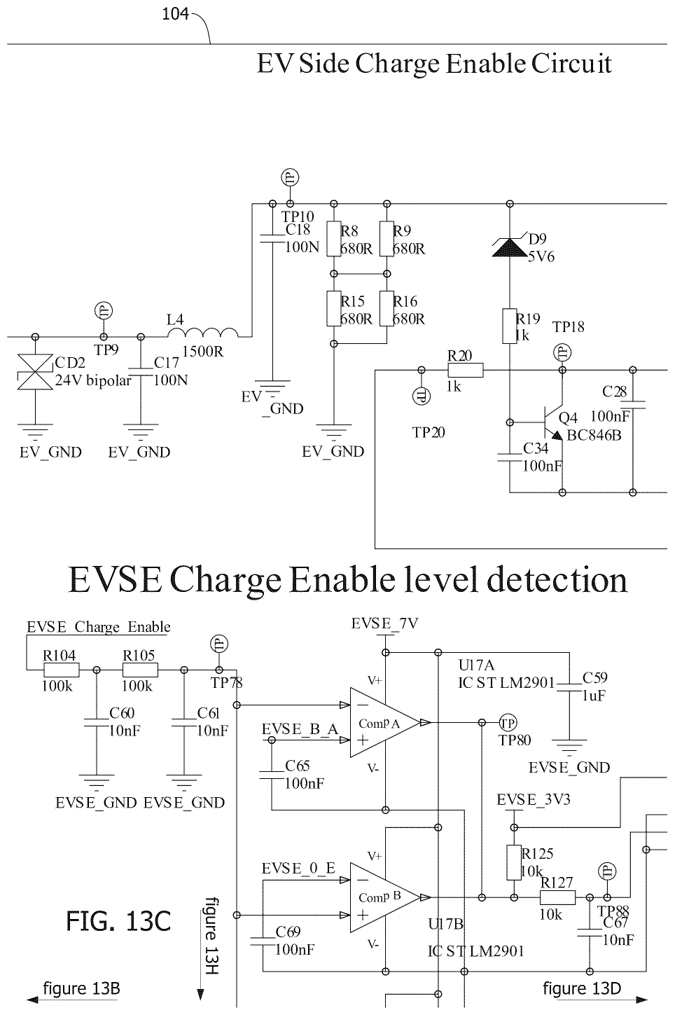

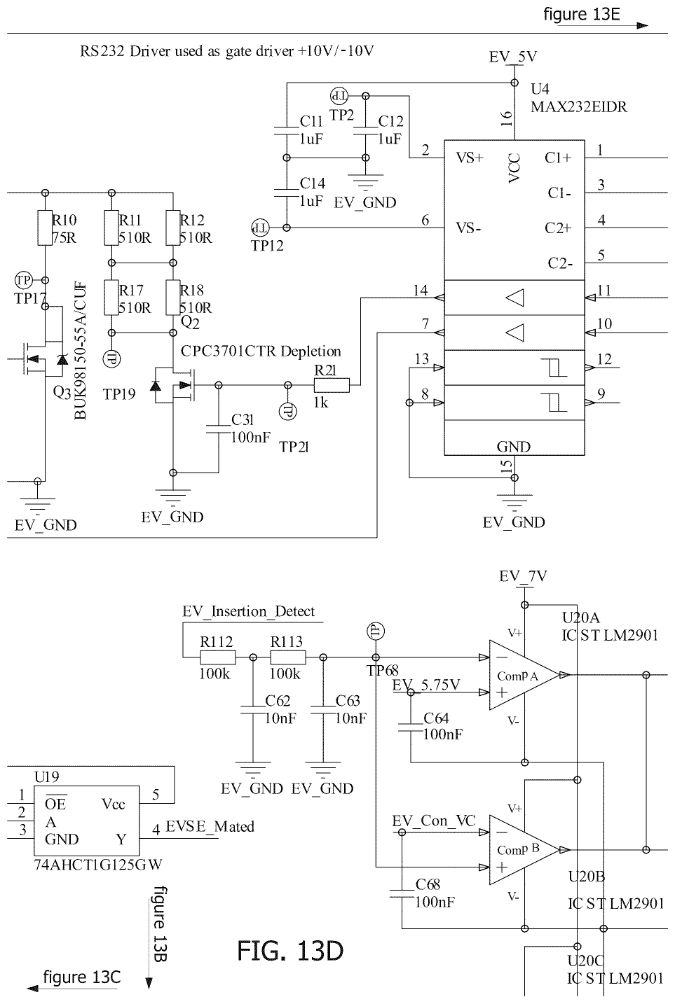

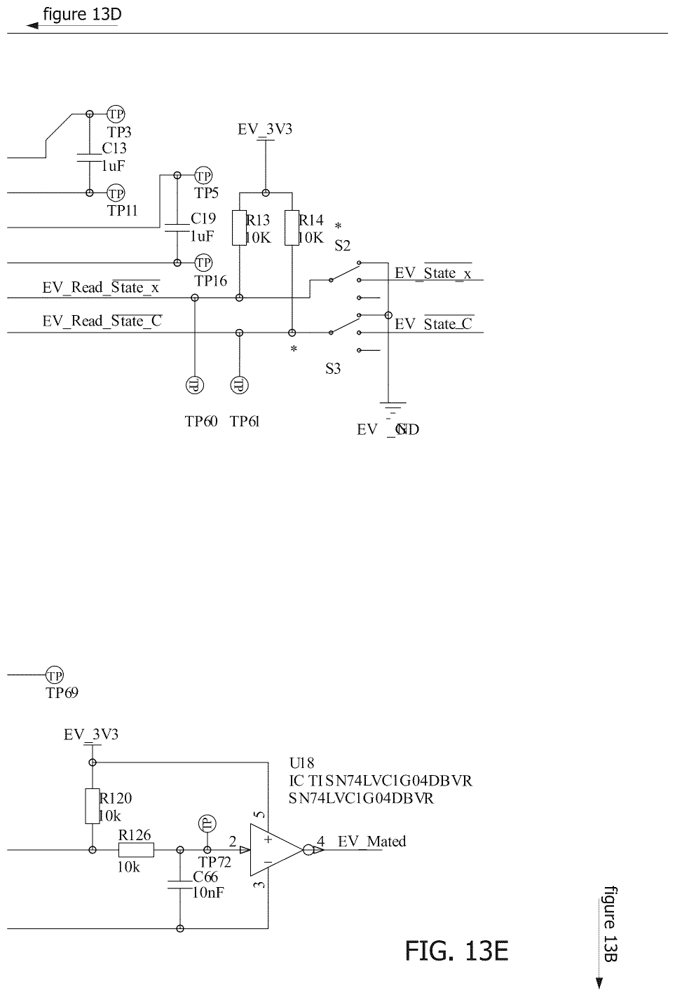

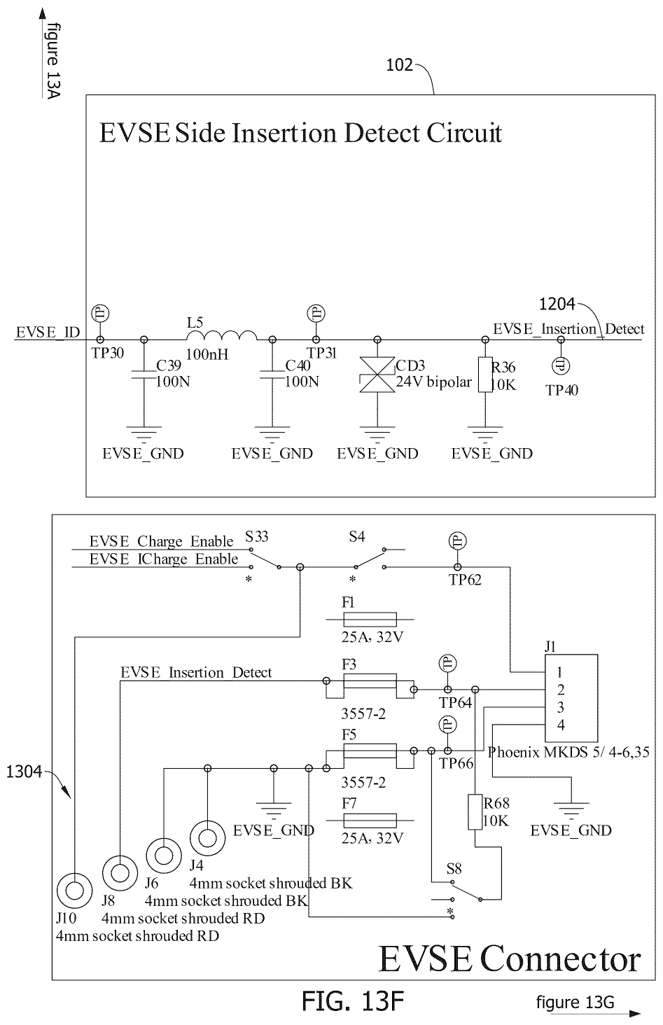

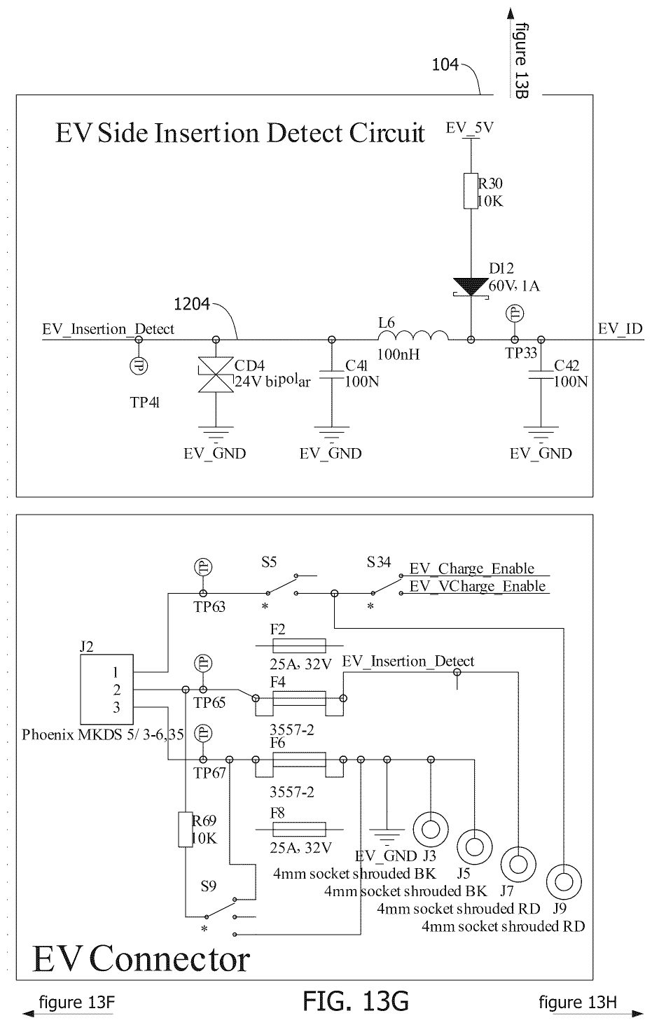

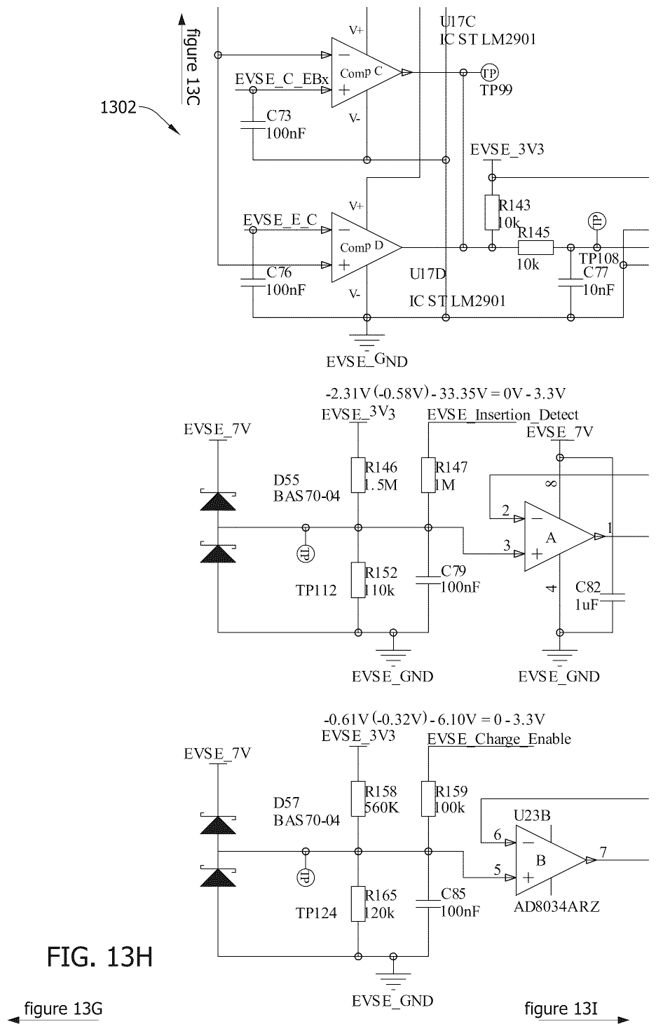

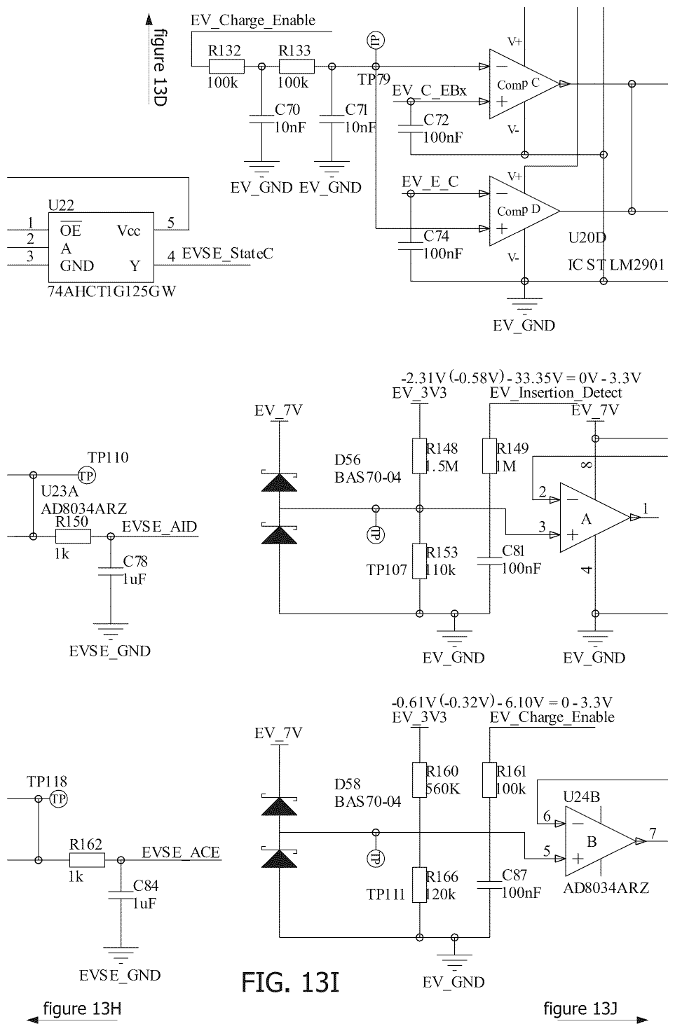

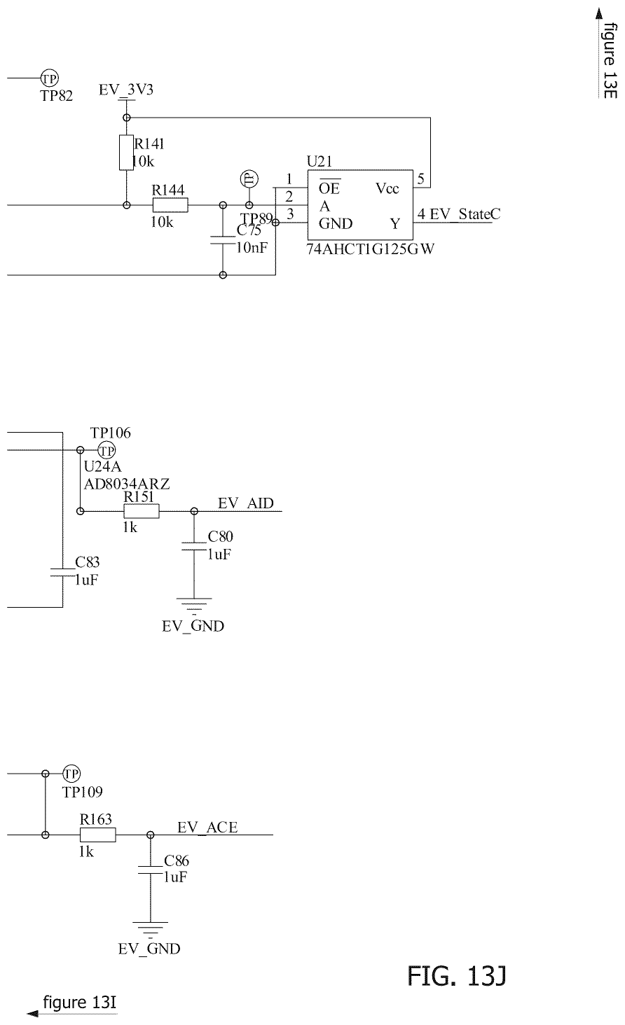

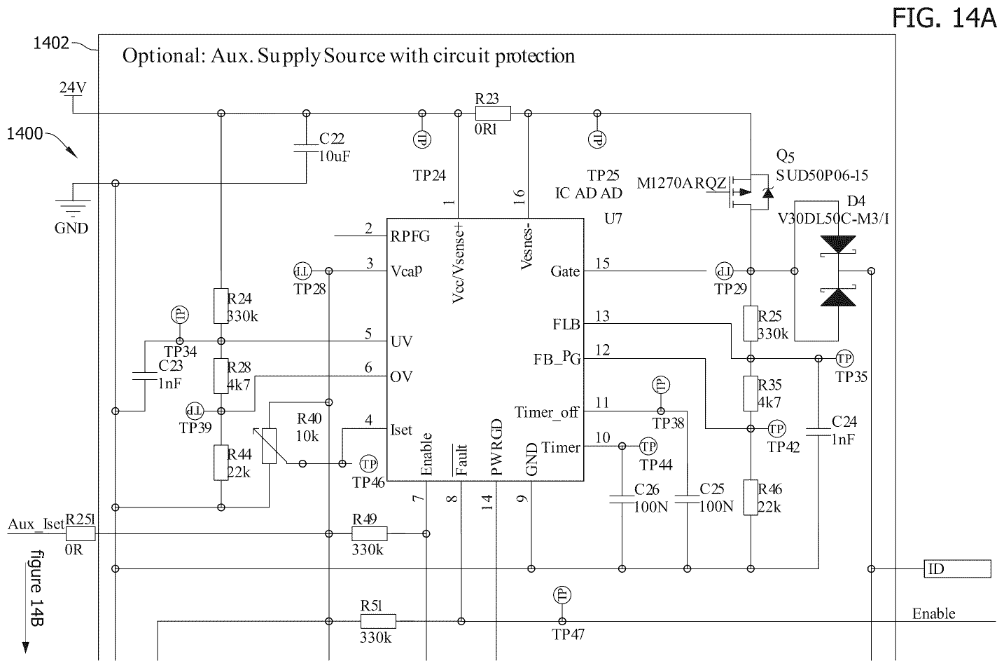

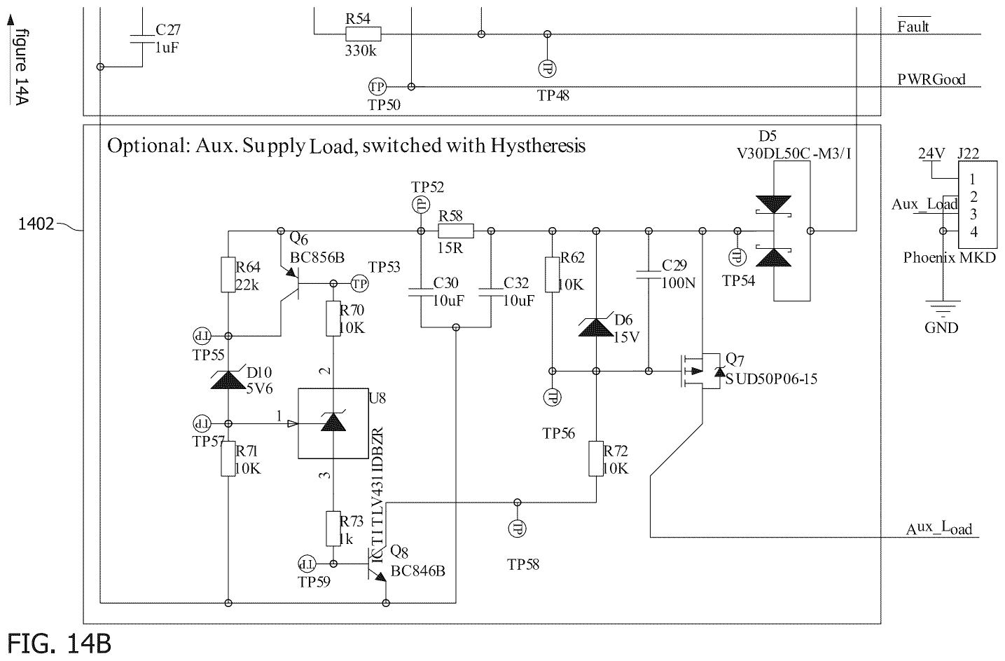

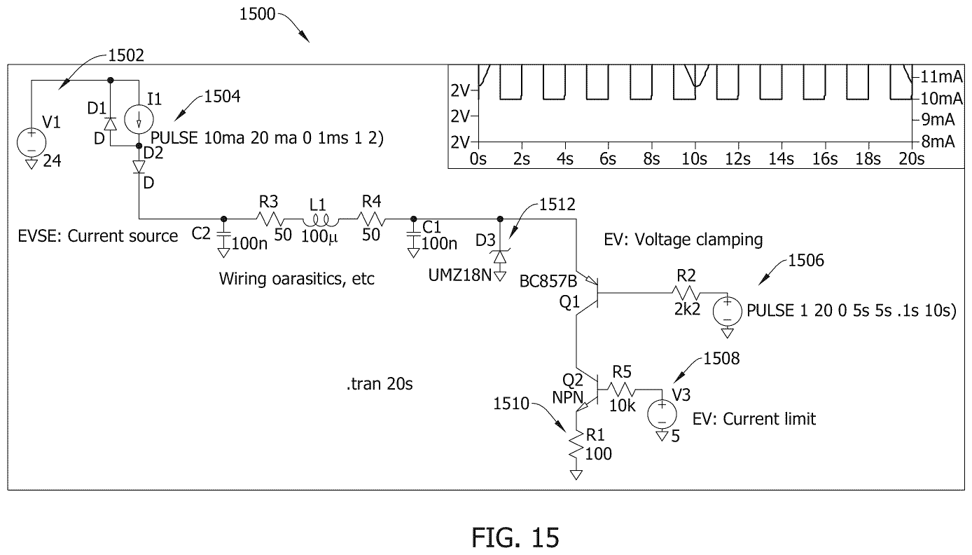

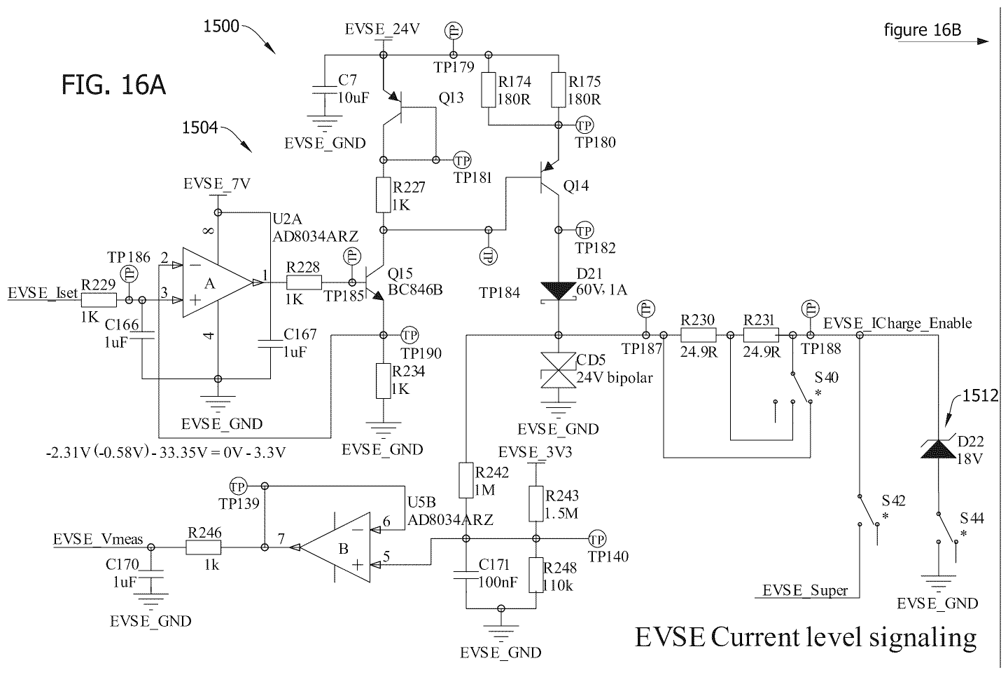

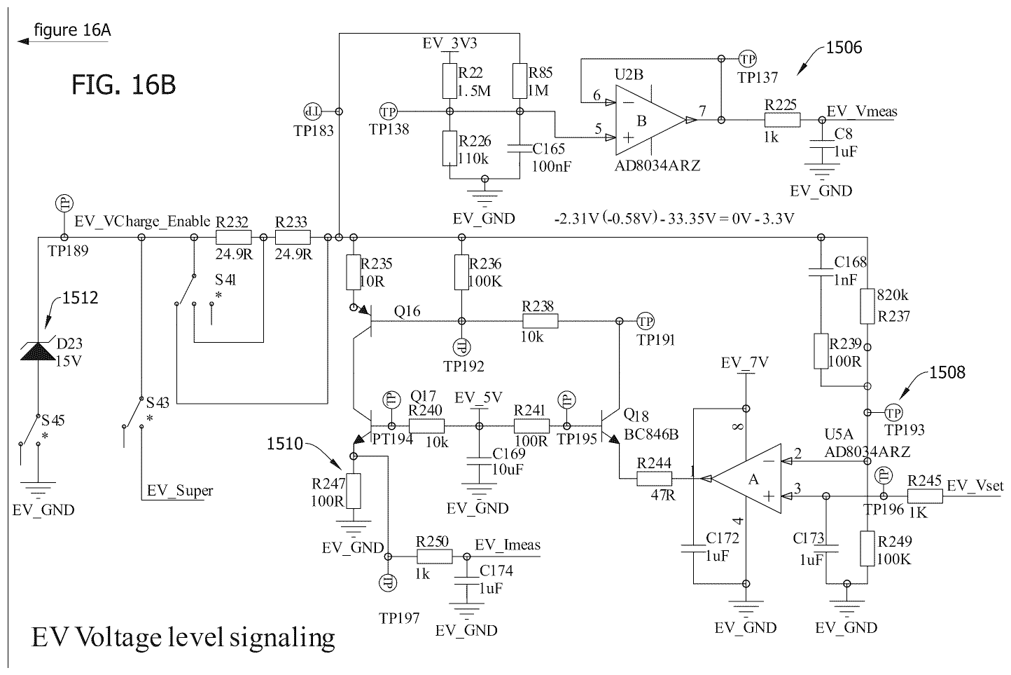

FIGS. 13A-13J depict a schematic diagram illustrating additional detail of the circuit shown in FIG. 12.

FIGS. 14A and 14B depict a schematic diagram of an example circuit for providing an auxiliary power supply over an insertion detection line for use in the circuit shown in FIG. 12.

FIG. 15 depicts a schematic diagram another example circuit for serving as an interface for serving as an interface between electric vehicle supply equipment and an EV such as those shown in FIG. 1 that utilizes current level and/or voltage level signaling.

FIGS. 16A and 16B depict a schematic diagram illustrating additional detail of the circuit shown in FIG. 15.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), an application specific integrated circuit (ASIC), and other programmable circuits, and these terms are used interchangeably herein. In the embodiments described herein, “memory” may include, but is not limited to, a computer-readable medium, such as a random-access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the example embodiment, additional output channels may include, but not be limited to, an operator interface monitor or heads-up display. Some embodiments involve the use of one or more electronic or computing devices. Such devices typically include a processor, processing device, or controller, such as a general-purpose central processing unit (CPU), a graphics processing unit (GPU), a microcontroller, a reduced instruction set computer (RISC) processor, an ASIC, a programmable logic controller (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are not intended to limit in any way the definition and/or meaning of the term processor and processing device.

The embodiments described herein include a communications interface between electric vehicle supply equipment (EVSE) and an electric vehicle (EV). The communication interface includes a first connection configured to connect to a controller of the EVSE and a second connection configured to connect to a controller of the EV. The communication interface further includes a plurality of communication conductors coupled between the first and second connections for communication between the controller of the EVSE and the controller of the EV. Communications over the communication conductors may be implemented according to one or more signaling protocols such as, for example Ethernet, controller area network (CAN), and/or current- or voltage-level signaling.

In some embodiments, the controller of the EVSE is configured to supply power to the controller of the EV over one or more of the plurality of communication conductors, and/or the controller of the EV is configured to supply power to the controller of the EVSE via the plurality of communication conductors.

In some embodiments, the controllers are configured to superimpose different types of communication signaling, as described in further detail below, on certain sets of the communication conductors. This may include superimposition of high level communication and low level communication signals and/or “multilingual” configurations in which different types of high level communication formats are used in parallel.

While generally described herein with respect to use in an EV charging system, any of the components described herein may be used in contexts other than an EV charging system. For example, some of the components described herein may be used for testing other components for future use within an EV charging system.

FIG. 1 is a block diagram of an charging system 100 in an exemplary embodiment. In this embodiment, charging system 100 includes EVSE 102 and a charging connector 106. EVSE 102 is configured to supply electrical power to an EV 104 through charging connector 106. While described herein with respect to a complete charging system 100, it should be appreciated that any of the components described herein may be implemented outside the context of a complete charging system 100, such as in a testing environment, and may include features specific for testing.

In this embodiment, EV 104 includes battery 108, which may store electrical energy for use in powering EV 104. Accordingly, EV 104 may be a battery electric vehicle (BEV), a plug-in electric vehicle, or a hybrid electric vehicle (HEV), or any other type of vehicle capable of being charged from an external electrical source such as EVSE 102. EV 104 further includes a charging inlet 110 that is configured to couple with charging connector 106 and to convey electric current supplied from charging connector 106 to battery 108. Charging inlet 110 is further configured such that the coupling between charging inlet 110 and charging connector 106 enables a transmission of communication signals between EVSE 102 and EV 104 through charging connector 106, as described in further detail below.

In the exemplary embodiment, charging connector 106 includes an input interface 112 and an output interface 114. Input interface 112 is configured to engage with EVSE 102, and output interface 114 is configured to engage with charging inlet 110 of EV 104. In some embodiments, input interface 112 and output interface 114 are structured according to a predefined charging connector format. In the example embodiment, charging connector 106 further includes at least one power conductor 116 configured to convey current between EVSE 102 and EV 104. The number of power conductors 116 may depend on the connector format of input interface 112 and/or output interface 114. In some embodiments, charging connector 106 includes at least three power conductors 116 corresponding to a positive DC pin, a negative DC pin, and a protective earth (PE) pin. In such embodiments, each power conductor 116 is routed from its corresponding pin on input interface 112 to its corresponding pin on output interface 114.

In the example embodiment, charging connector 106 further includes one or more communication conductors 118 that connect input interface 112 and output interface 114 to enable communication signals to be transmitted between EVSE 102 and EV 104. These communication signals include low level communication (LLC) signals and high level communication (HLC) signals. LLC signals are basic signals used to quickly detect errors, such as EVSE 102 and EV 104 becoming disconnected. HLC signals are, by comparison, data-intense signals, which are used for authentication and coordination of charging between EVSE 102 and EV 104. In some embodiments, communication conductors 118 include lines such as a control pilot (CP) line configured to carry a CP signal, which may be used to transfer information such as a charging level, a maximum charging current, and commands to start or stop charging between EVSE 102 and EV 104, and a proximity pilot (PP) line configured to carry a PP signal, which indicates a connection is present between EVSE 102 and EV 104.

One or more different signaling configurations may be used for such communication. Examples of signaling configurations include (1) a four-wire configuration including a charge enable line and an insertion detection line, with auxiliary power supply over the insertion detection line; (2) a two-wire configuration; or (3) current level and/or voltage level signaling, which may be used for signaling in high-noise environments. Each of these configurations is described in further detail below.

One or more different HLC communication physical layers (PHYs) may be used to implement these configurations. Examples of PHYs include (1) 10Base-TIS; (2) 100Base-T1; (3) Differential Power Line Communication (PLC); or Controller Area Network Flexible Data-Rate (CAN-FD).

In some embodiments, superimposition, that is, the use of a single line for multiple different signals, is used. For example, superimposition can be used in any of the three example signaling configurations described above.

In some embodiments, some of communication conductors are configured to carry power, in a configuration sometimes referred to herein as “power over data lines.” Power over data lines can be used to supply power to control and/or logic components. For example, rather than using an auxiliary battery (e.g., a twelve volt, eighteen volt, twenty four volt, or forty two volt battery) of EV 104, control and/or logic components of battery 108 and/or charging inlet 110 may receive power from EVSE 102 via one or more of communication conductors 118. In some such embodiments, power over data lines is used in combination with superimposition of signals. In another example, the power over data lines can be used to supply power from one board to another in a blackout start situation.

In some embodiments, multiple communication interfaces (e.g., some combination of the signaling formats described above) are coupled in parallel using jumper wires, with one of the communication interfaces being active at a given time, which may enable multilingual communication via a set of communication conductors 118. In such embodiments, one or more switches can be used to direct signals transmitted through communication conductors 118 to the active communication interface.

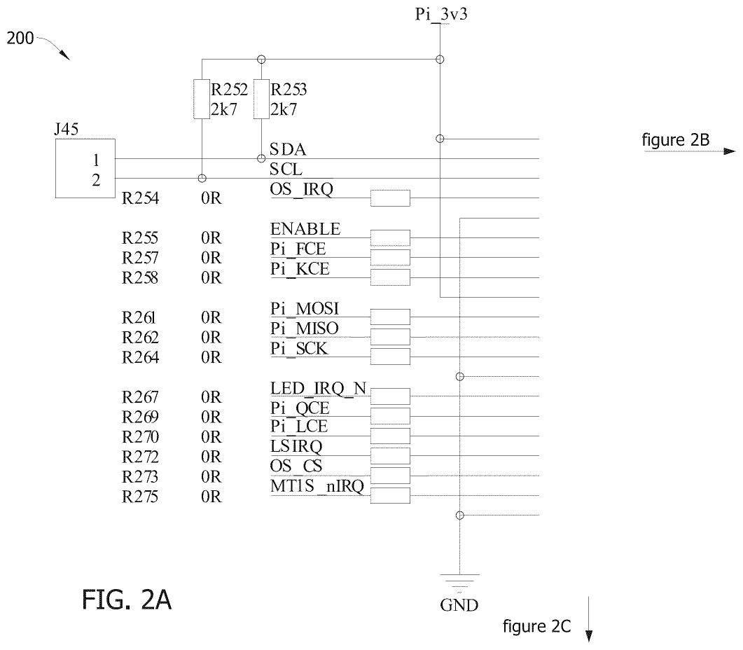

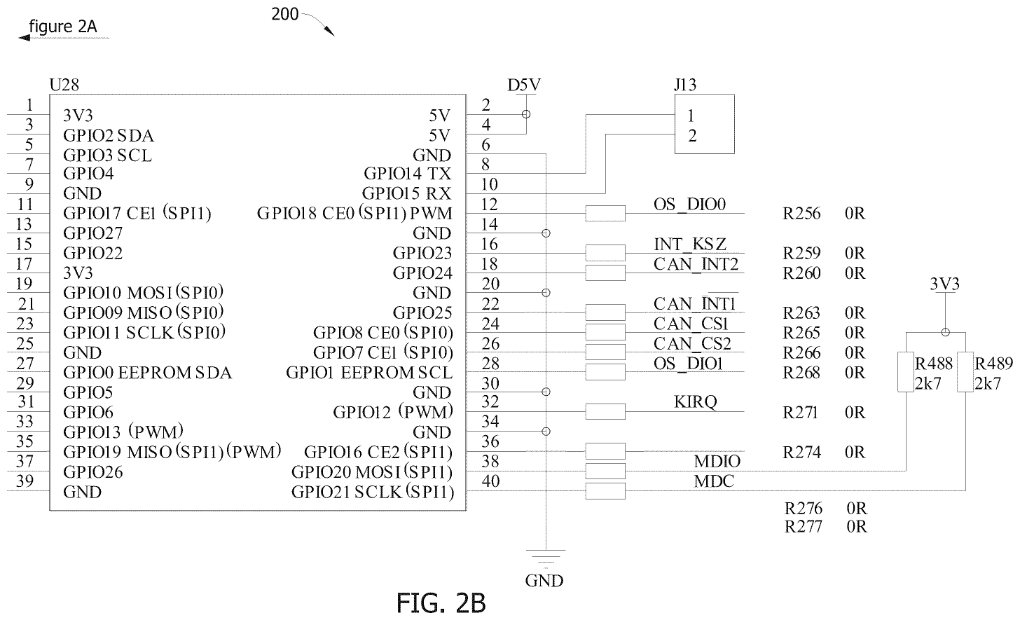

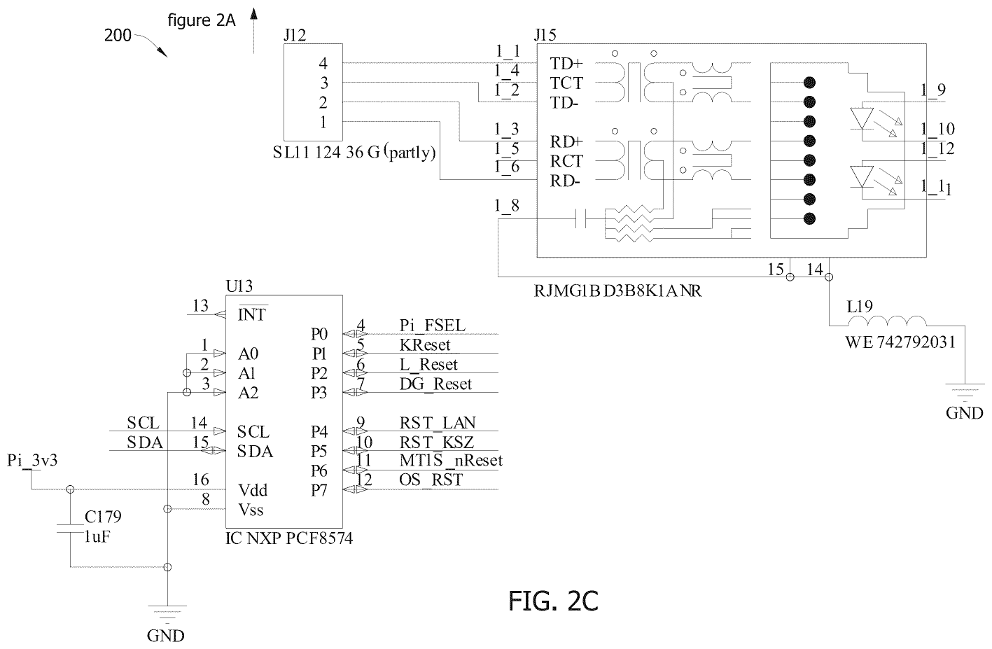

FIGS. 2A-2C, FIGS. 3A-3F, FIGS. 4A and 4B, FIGS. 5A-5C, FIGS. 6A-6E, FIGS. 7A-7D, FIGS. 8A-8F, FIGS. 9A-9D, FIGS. 10A and 10B, FIGS. 11A and 11B, FIG. 12, FIGS. 13A-13J, FIGS. 14A and 14B, FIG. 15, and FIGS. 16A and 16B show components that are included in the charging system 100 and/or EV 104 to effectively and efficiently charge battery 108 of EV 104. These figures illustrate various different embodiments of potential circuit configurations that may be implemented in charging system 100 and/or EV 104, which in some example implementations may be used in combination with each other. The circuit configurations described in these figures enable charging system 100 and/or EV 104 to perform certain aspects of the functionality described above with respect to FIG. 1 such as, for example, superimposition, power over data lines, and/or multilingual communication, which may be applied in embodiments that utilize one or more of the different signaling protocols described herein. This functionality may improve the effectiveness of the charging system, for example, by (i) enabling EV 104 to be charged using fewer data lines connecting EVSE 102 to EV 104 and/or (ii) providing flexibility for a particular EVSE 102 to charge EVs 104 having different types of charging and/or communication formats.

FIGS. 2A-2C depict a schematic diagram of an example circuit board 200 that may be used to control and/or test various HLC interfaces (e.g., those between EVSE 102 and EV 104). In some embodiments, circuit board 200 includes a Raspberry Pi hardware attached on top (HAT) interface or a similar device, which may be selected based on computational needs and available power.

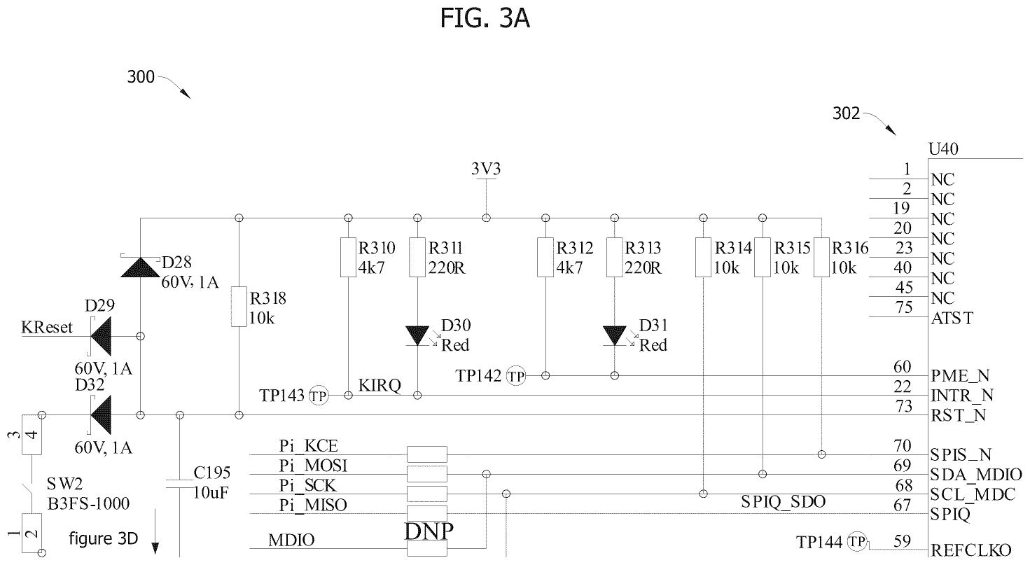

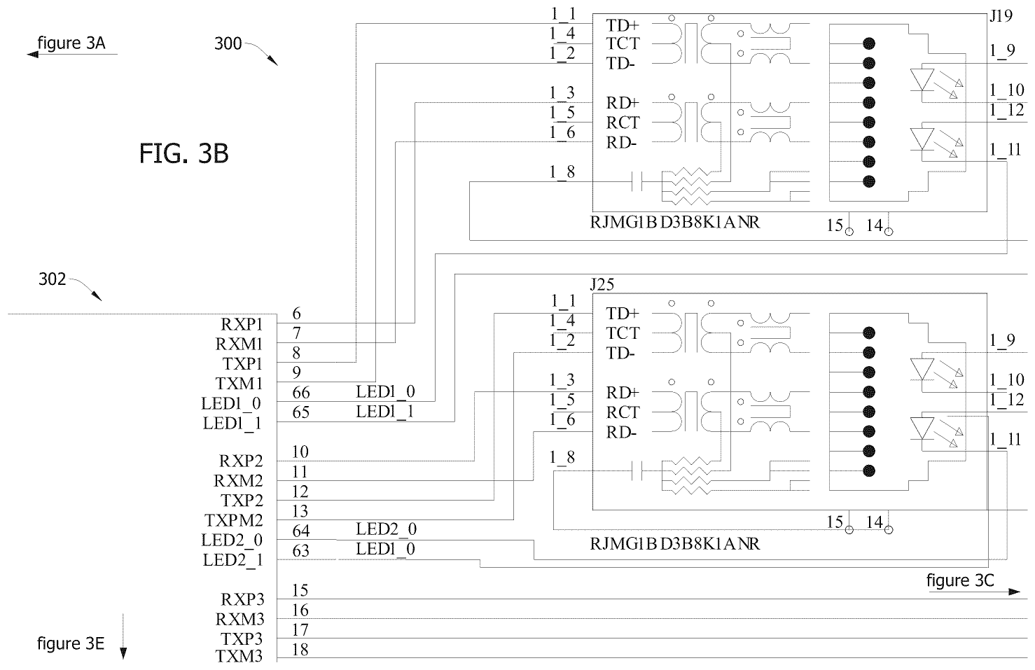

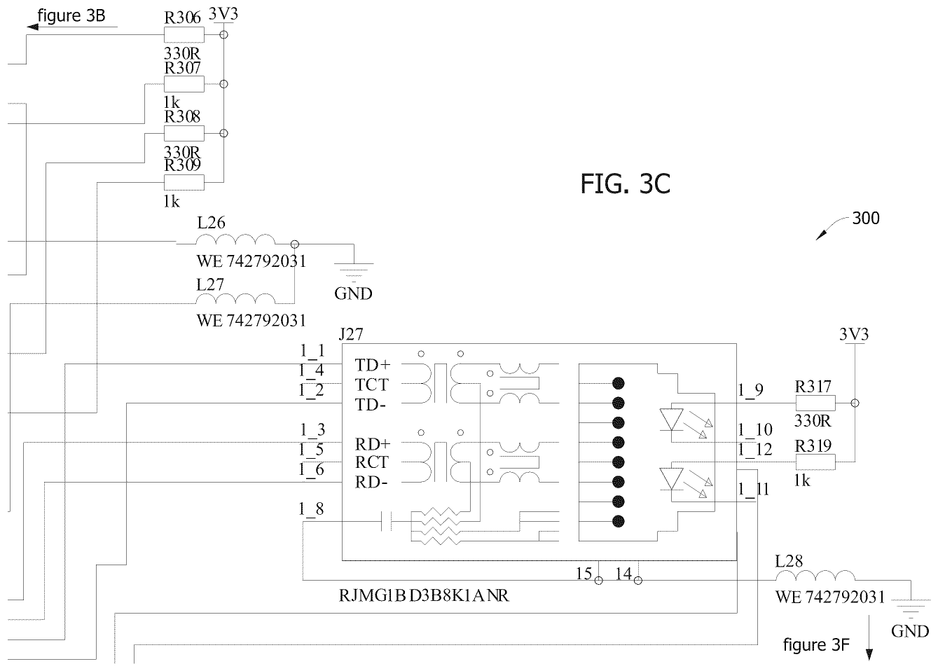

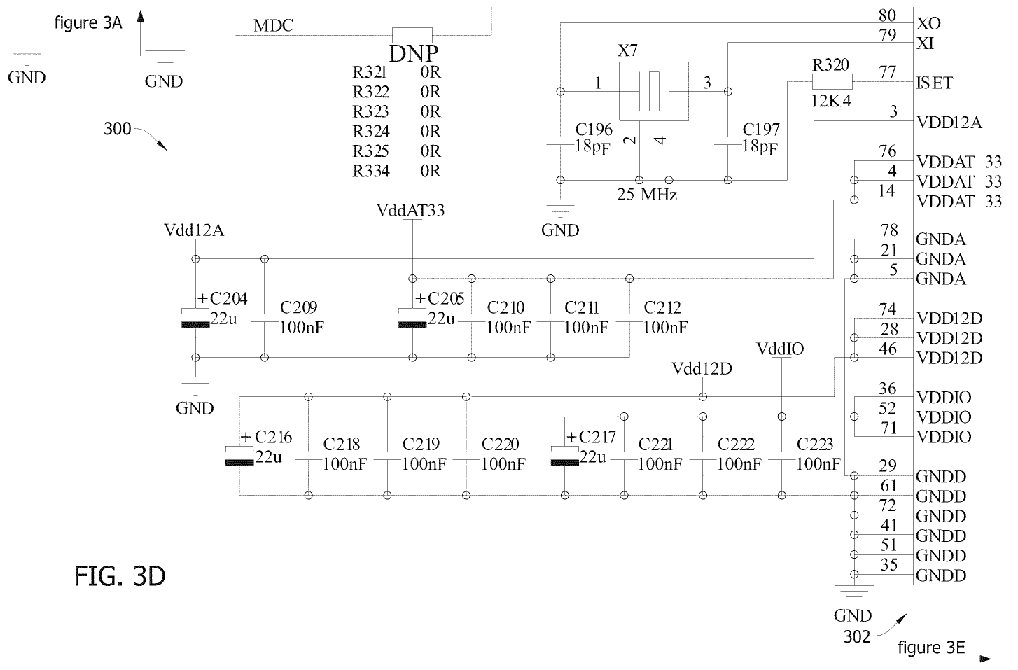

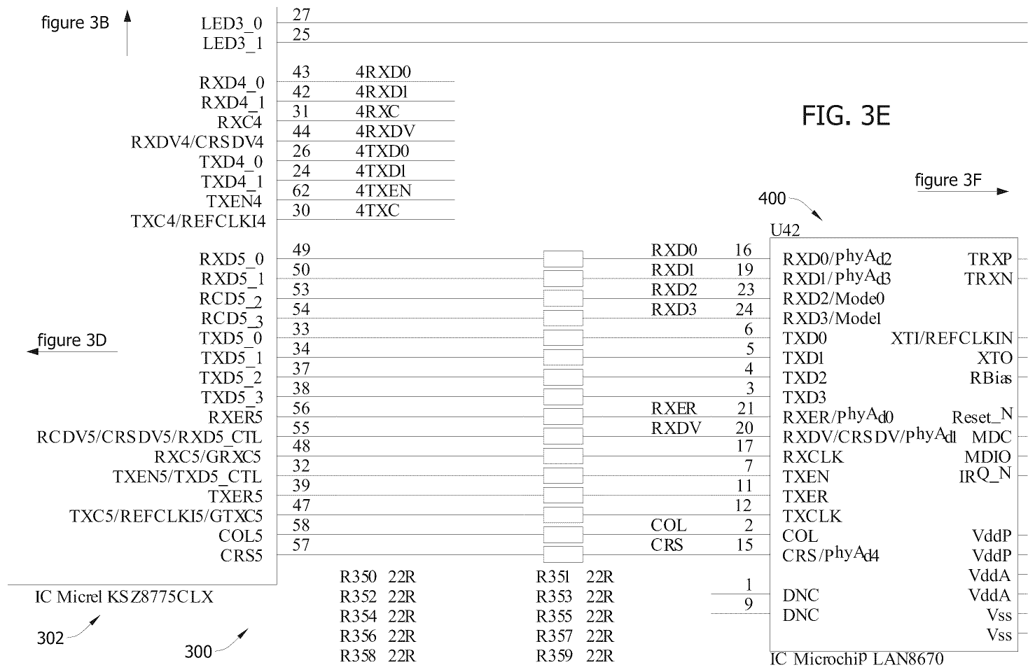

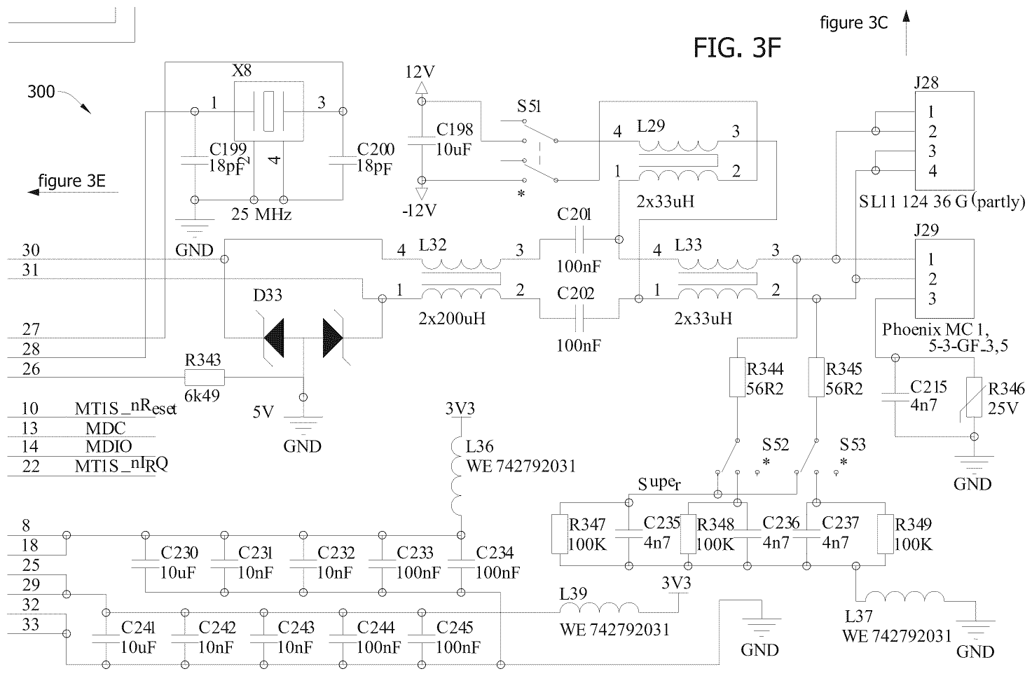

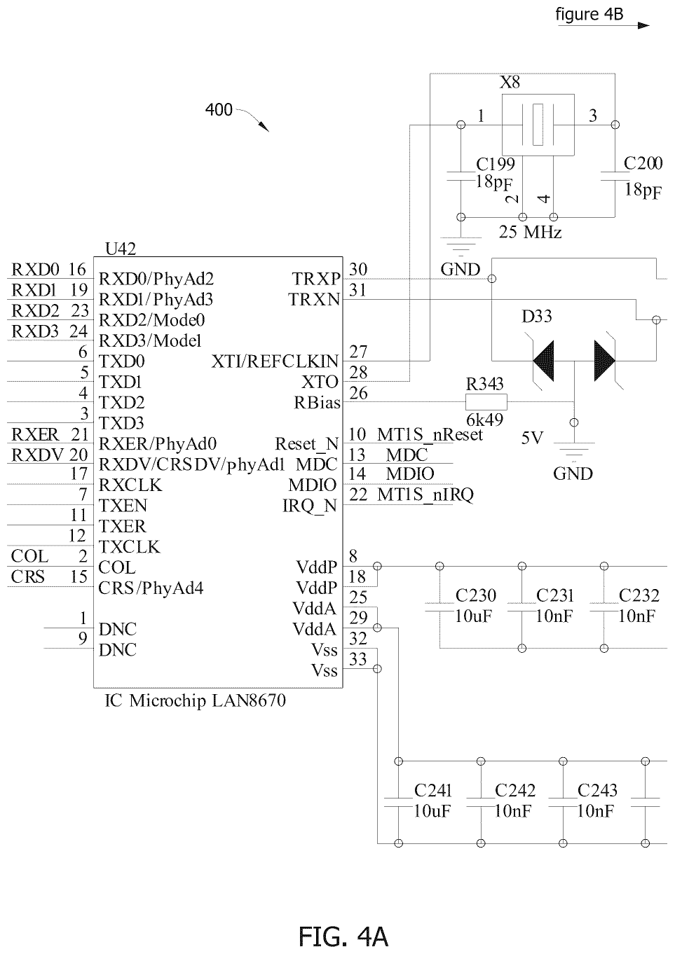

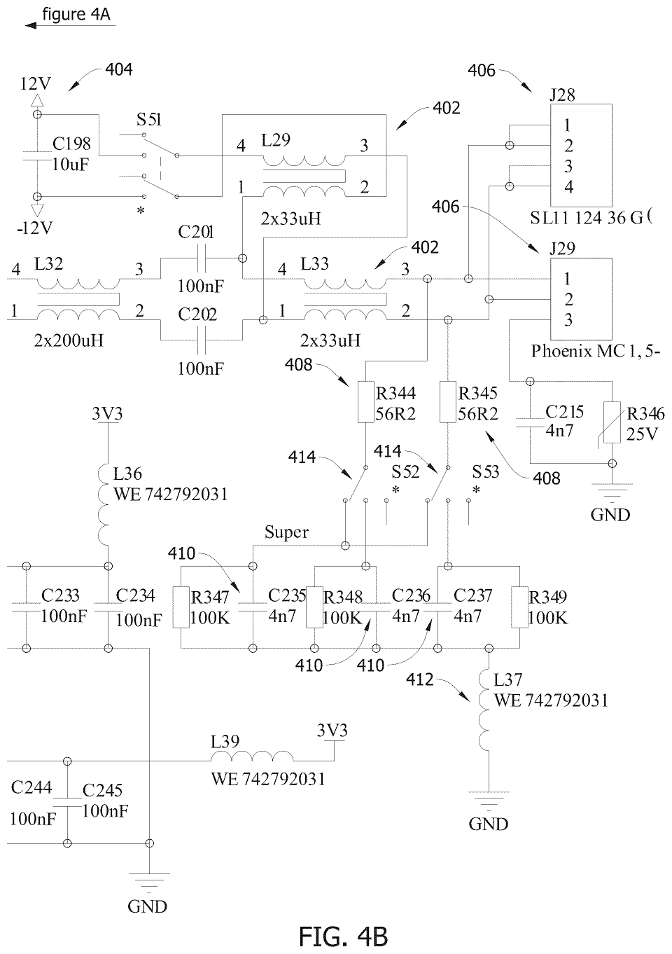

FIGS. 3A-3F depict a schematic diagram of a switch chip 300 that may be used in certain PHY implementations, such as 100Base-TX, Lumissil PLC, and/or 10Base-T1S. Switch chip 300 includes a circuit 400, which is described in further detail with respect to FIGS. 4A and 4B. Switch chip 300 further includes circuitry 302 configured to route control and communication signals from a component such as circuit board 200 to and from circuit 400.

FIGS. 4A and 4B depict a schematic diagram of an example circuit 400 for use in an Ethernet 10Base-T1S signaling configuration (e.g., between EVSE 102 and EV 104). Circuit 400 includes a set of common mode inductors 402, which enables power from a source 404 to be supplied over data lines 406. The same power voltage is applied to each pair of data lines 406, so that within each pair there is no differential voltage other than that representing the communication signal. As described above, power over data lines can be used to supply power to control and/or logic components. For example, rather than using an auxiliary twelve volt or eighteen volt battery of EV 104, control and/or logic components of battery 108 and/or charging inlet 110 may receive power from EVSE 102 via one or more of data lines 406.

Circuit 400 further includes termination resistors 408, which can be selectively coupled to ground via separate capacitors 410 and an inductor 412 using respective switches 414. In embodiments in which a power over data line is used, switches 414 can be set so that each termination resistor 408 is connected to ground through a separate capacitor 410, thus avoiding a situation where the entire voltage of source 404 is placed across termination resistors 408.

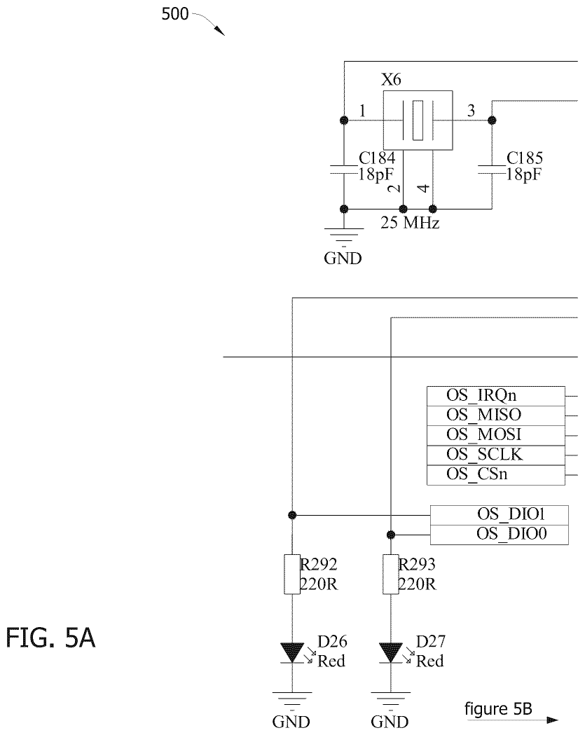

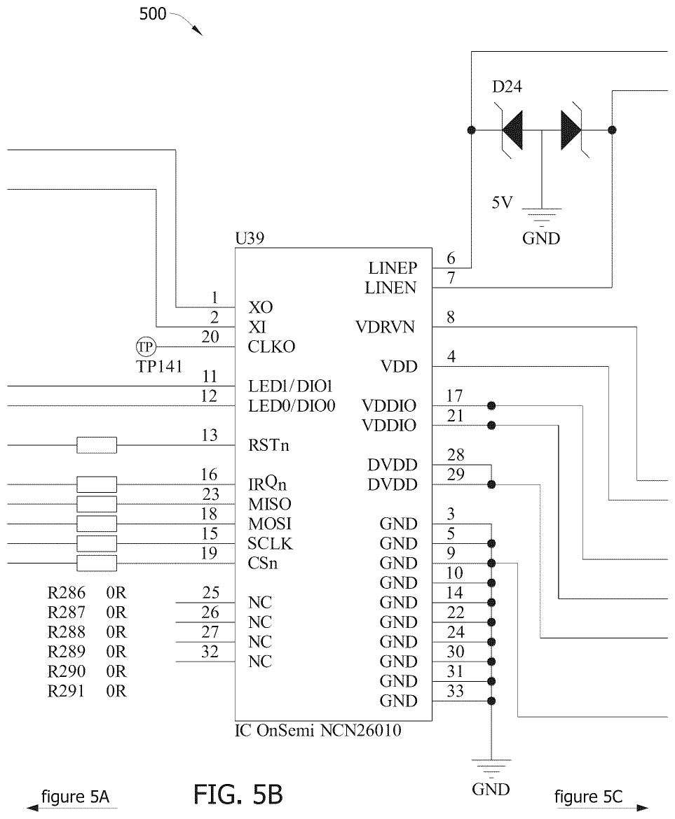

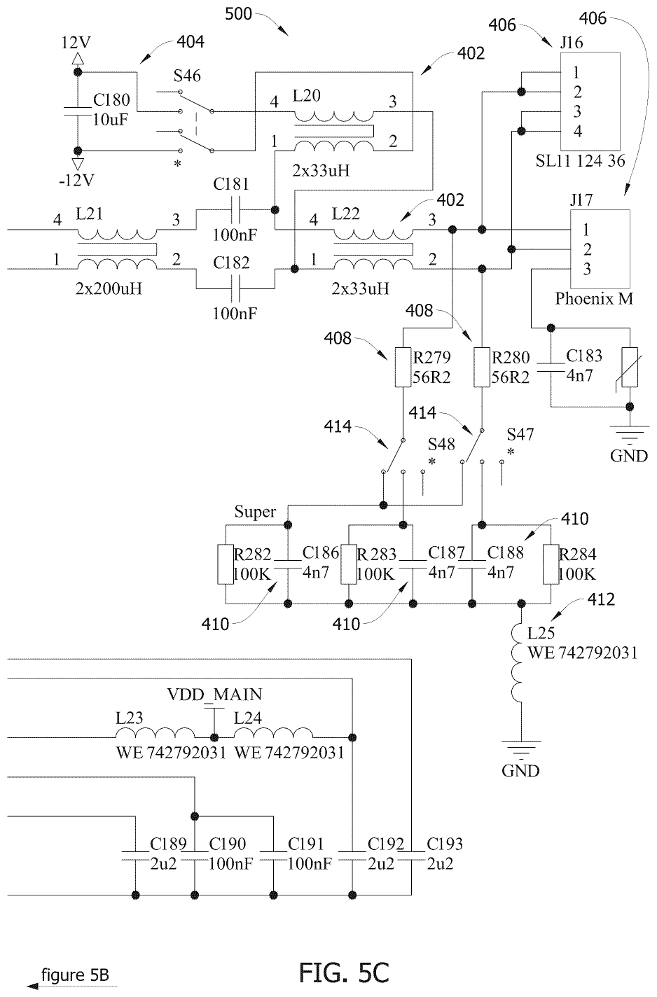

FIGS. 5A-5C depict a schematic diagram of another example circuit 500 for use in an Ethernet 10Base-T1S signaling configuration (e.g., between EVSE 102 and EV 104). Circuit 500 includes common mode inductors 402, source 404, data lines 406, termination resistors 408, capacitors 410, inductor 412, and switches 414, which generally function as described with respect to FIGS. 4A and 4B.

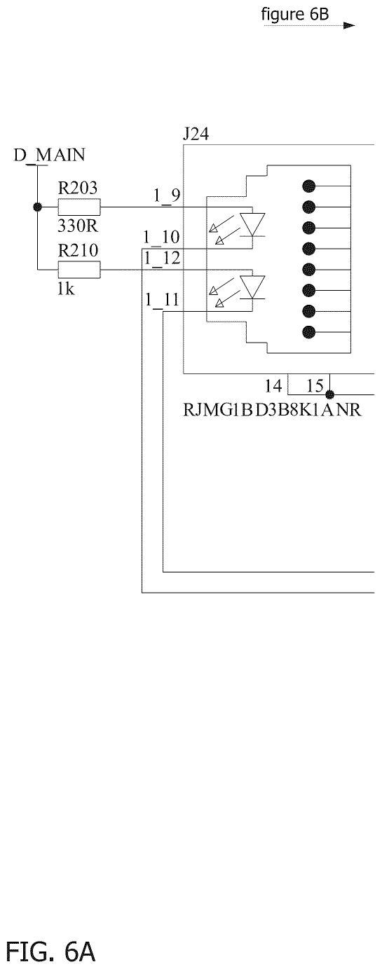

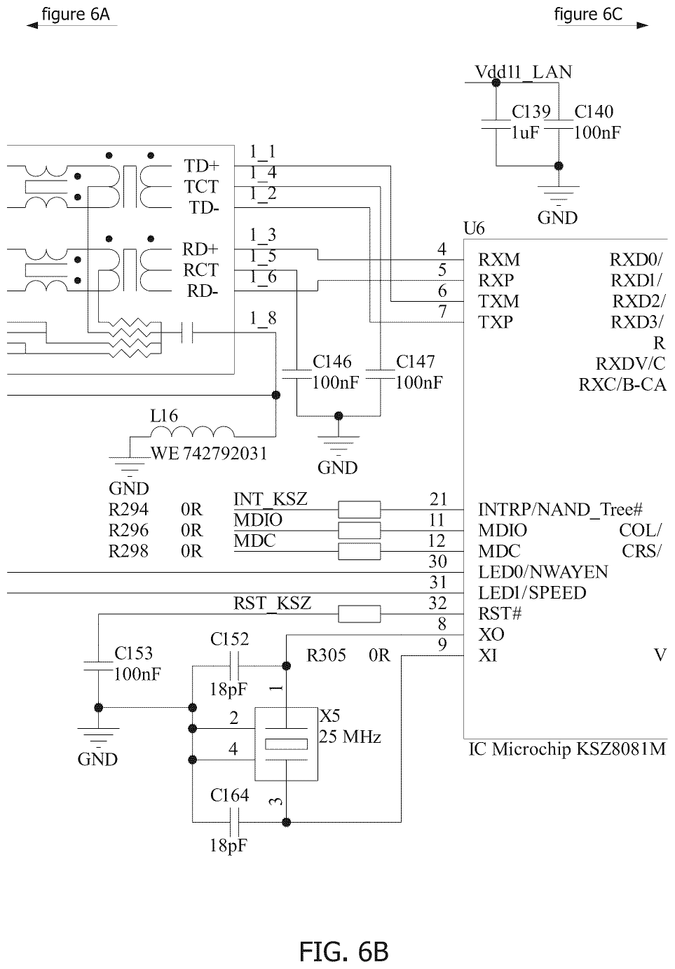

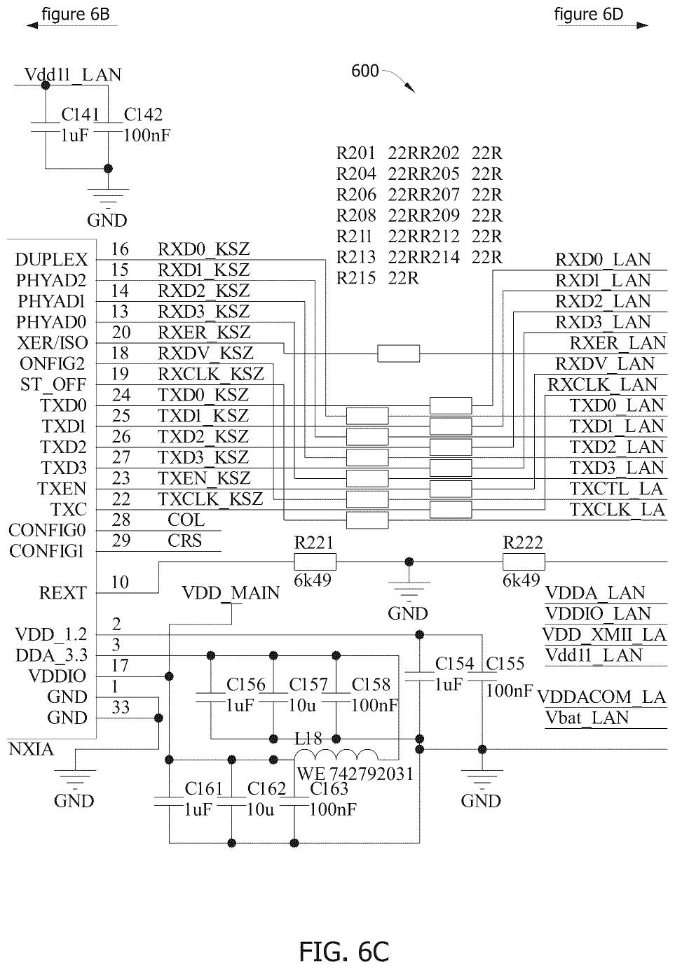

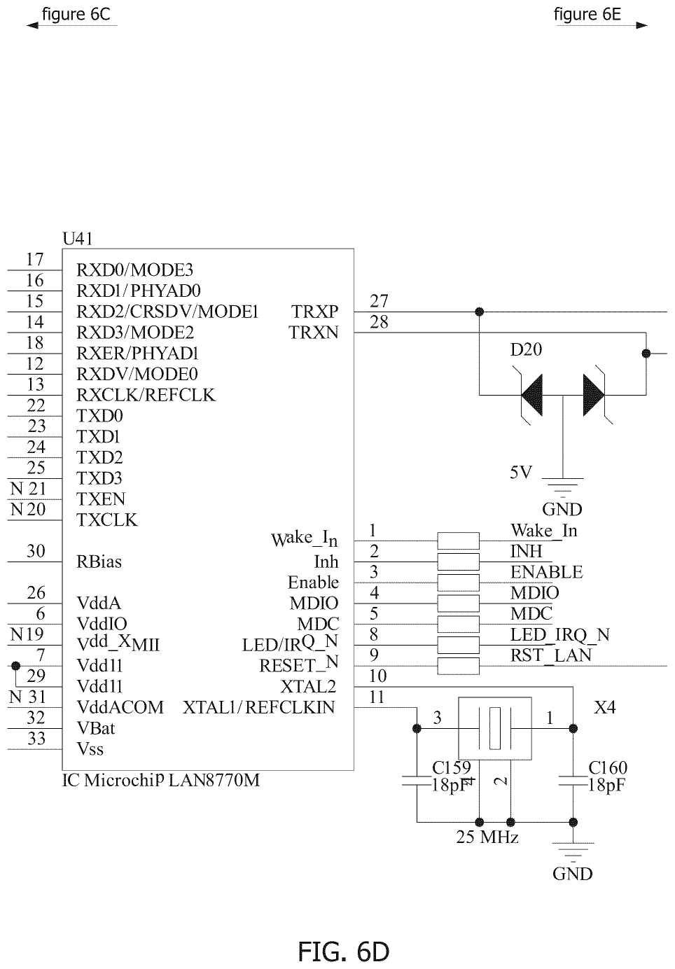

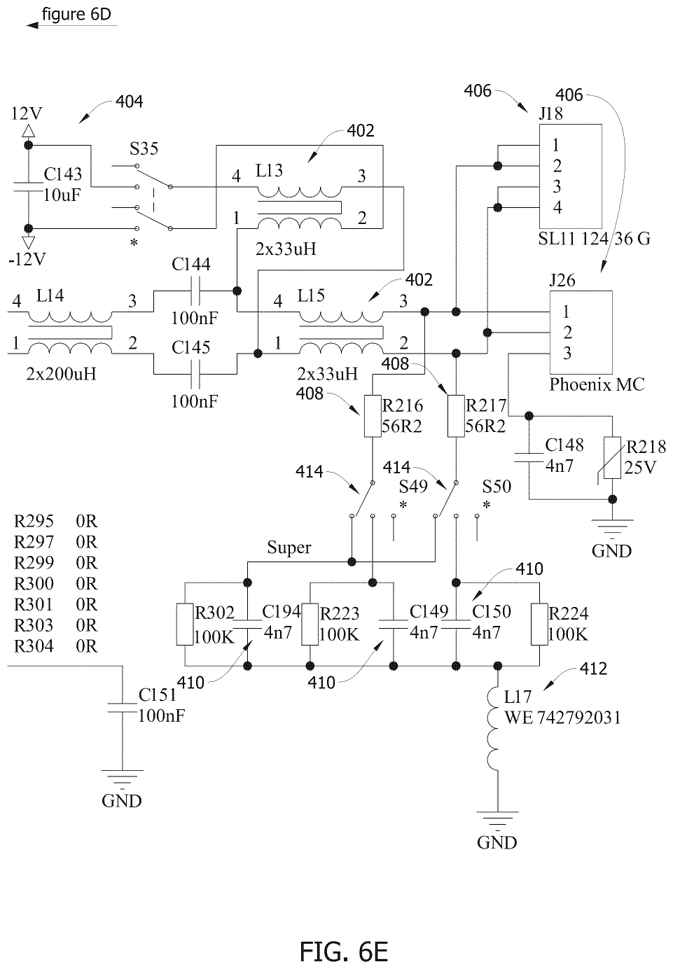

FIGS. 6A-6E depict a schematic diagram of an example circuit 600 for use in an Ethernet 100Base-T1 signaling configuration (e.g., between EVSE 102 and EV 104). Circuit 500 includes common mode inductors 402, source 404, data lines 406, termination resistors 408, capacitors 410, inductor 412, and switches 414, which generally function as described with respect to the circuit 400 of FIG. 4.

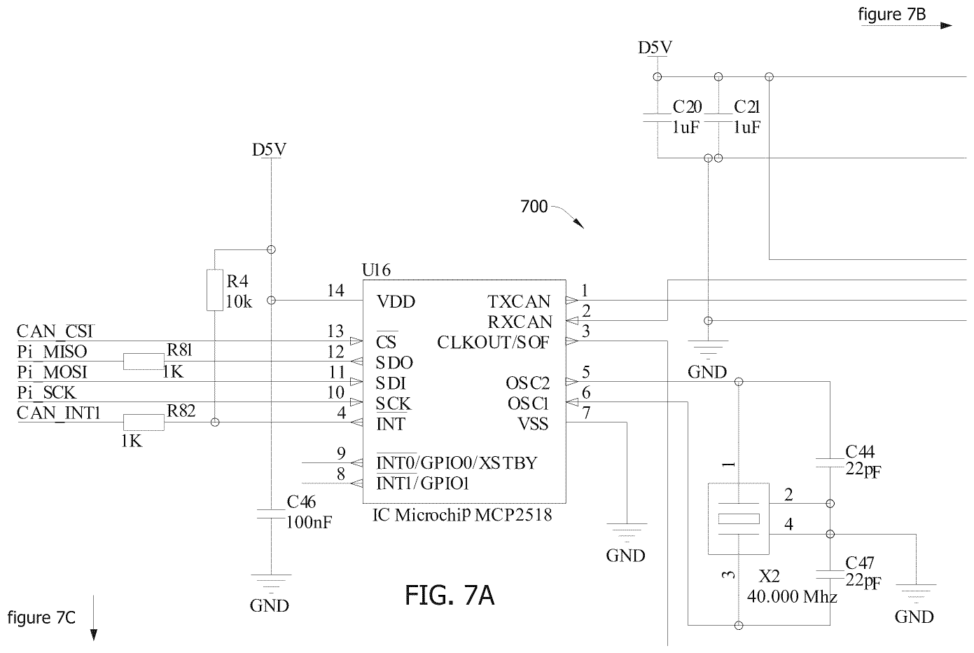

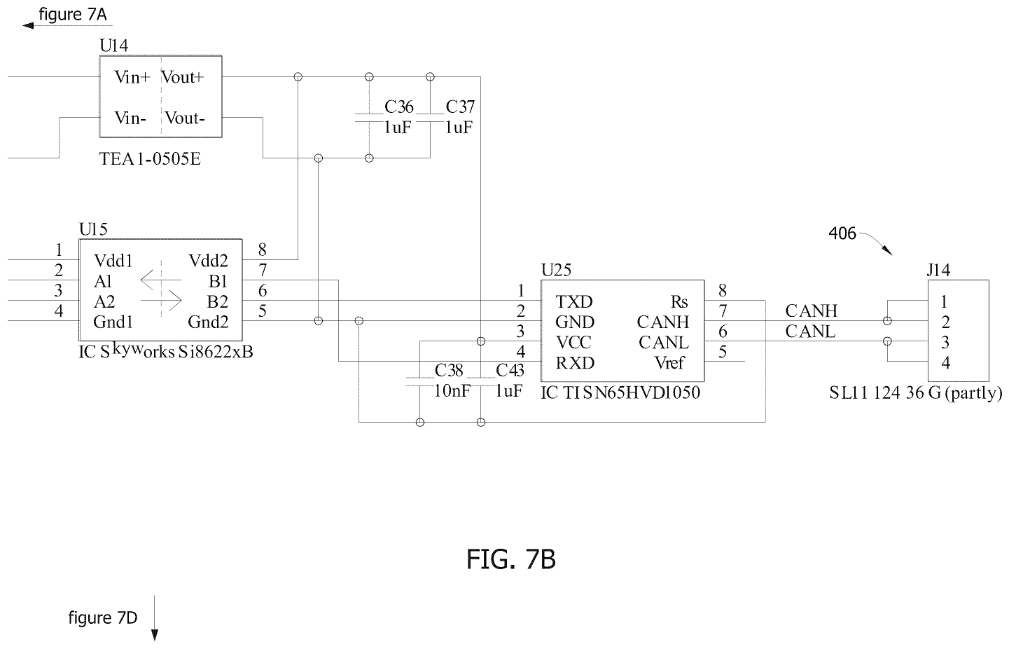

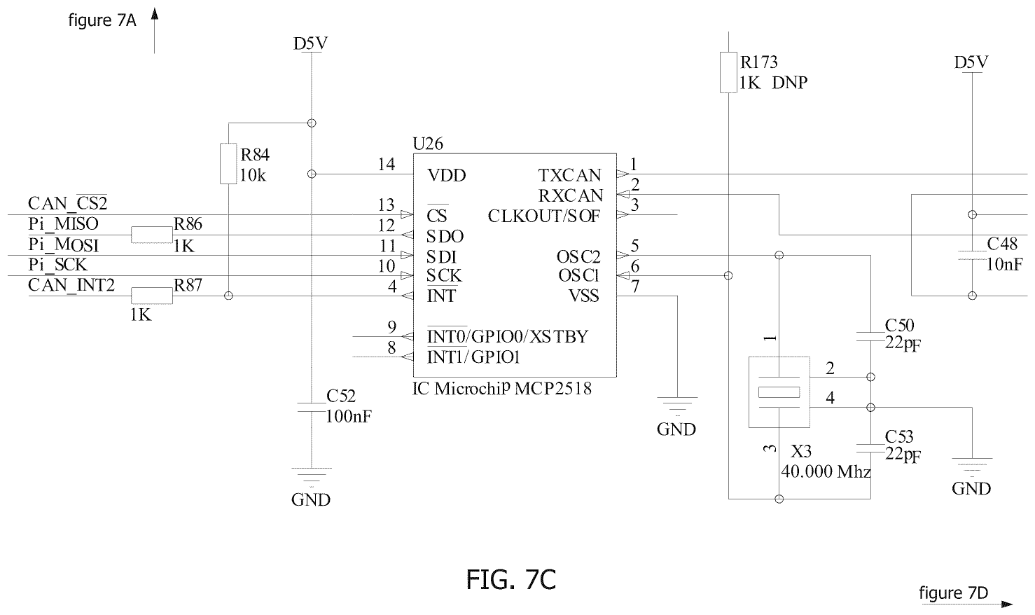

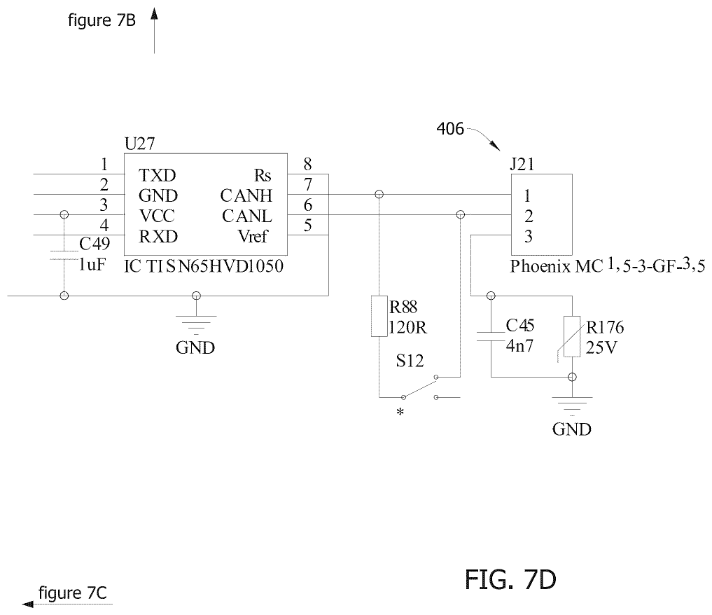

FIGS. 7A-7D depict a schematic diagram of an example circuit 700 for use in a CAN-FD signaling configuration (e.g., between EVSE 102 and EV 104). Circuit 700 includes data lines 406, which generally function as described with respect to the circuit 400 of FIGS. 4A and 4B. In the illustrated embodiment of microchip, data lines 406 are configured to carry CAN-FD and are not configured for power over data lines.

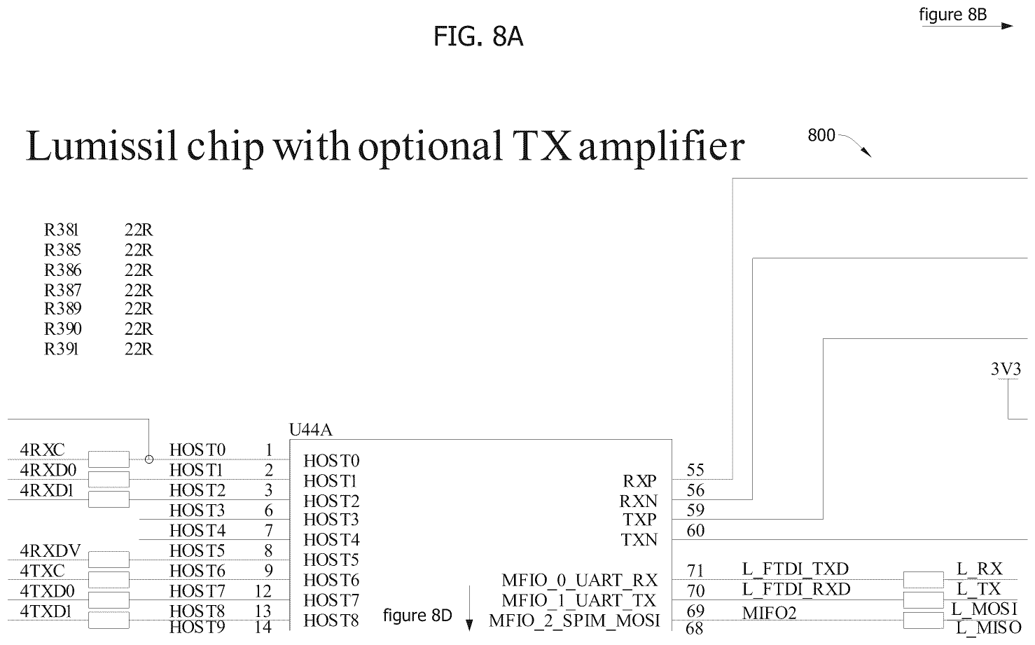

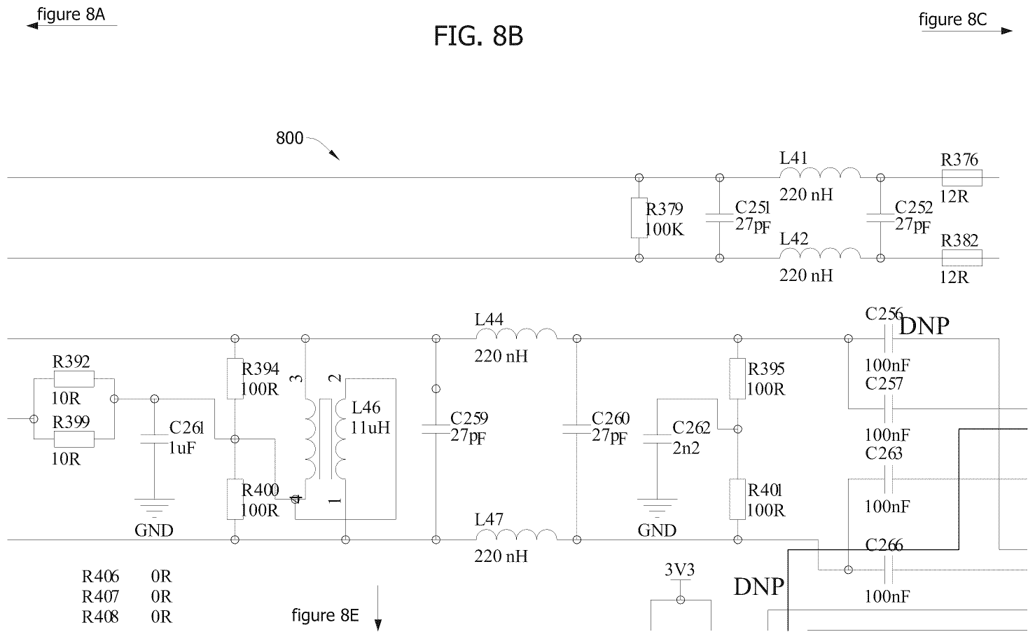

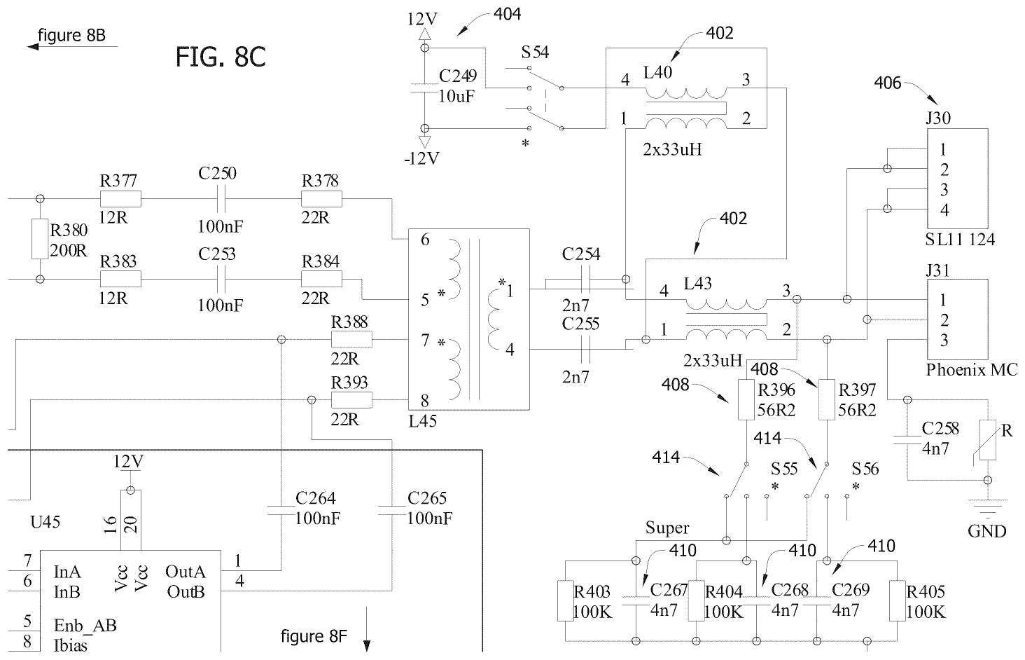

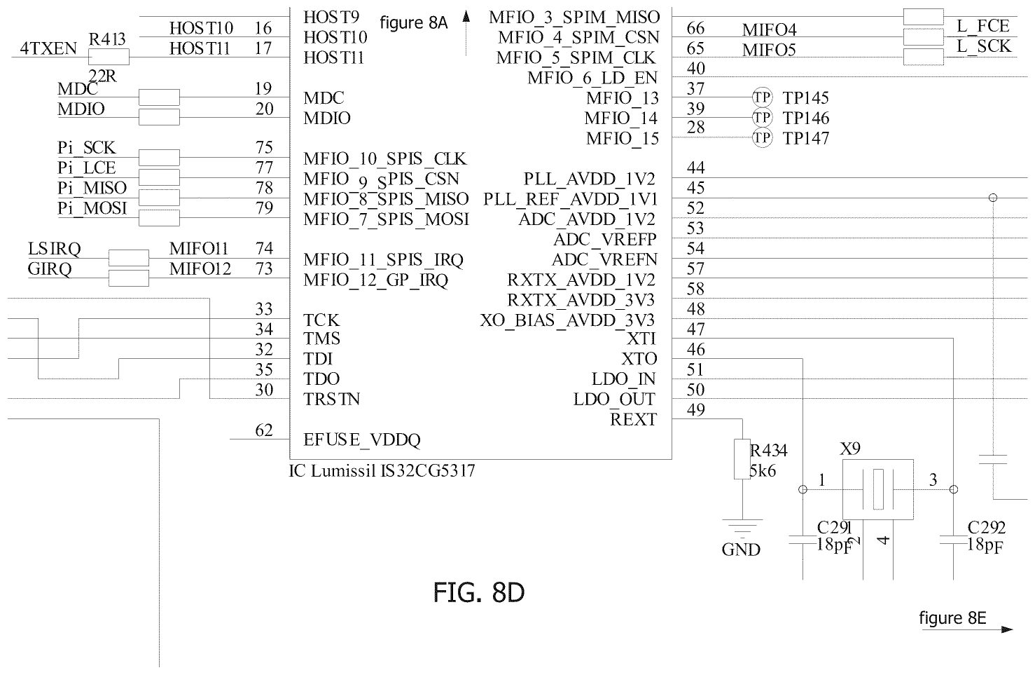

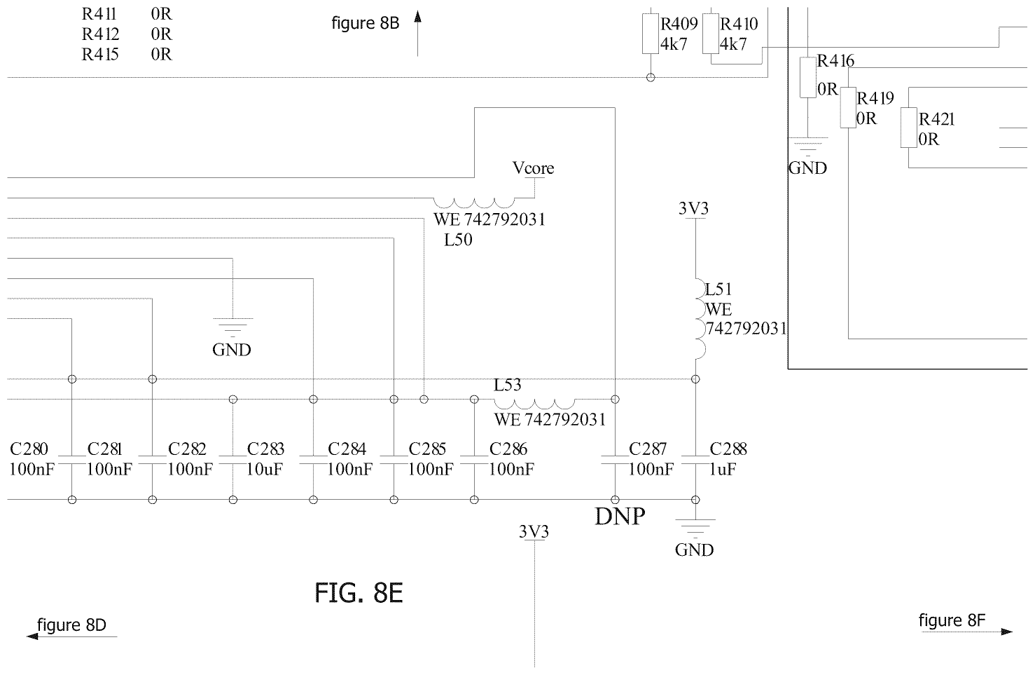

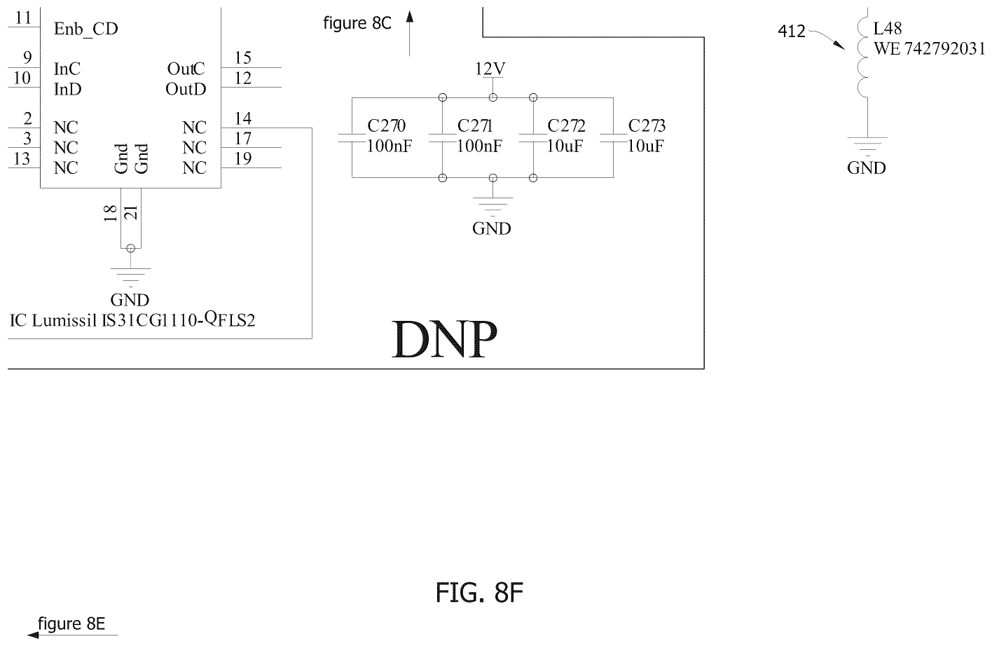

FIGS. 8A-8F depict a schematic diagram of an example circuit 800 for use in a differential PLC signaling configuration (e.g., between EVSE 102 and EV 104). Specifically, the embodiment shown in FIGS. 8A-8F utilizes a Lumissil chip. Circuit 800 includes common mode inductors 402, source 404, data lines 406, termination resistors 408, capacitors 410, inductor 412, and switches 414, which generally function as described with respect to FIGS. 4A and 4B.

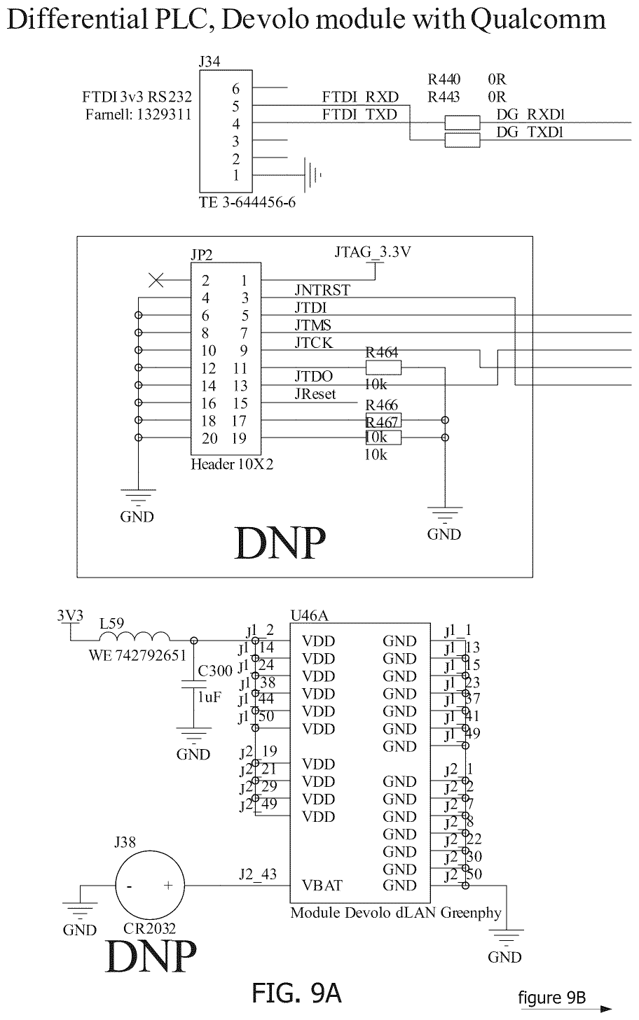

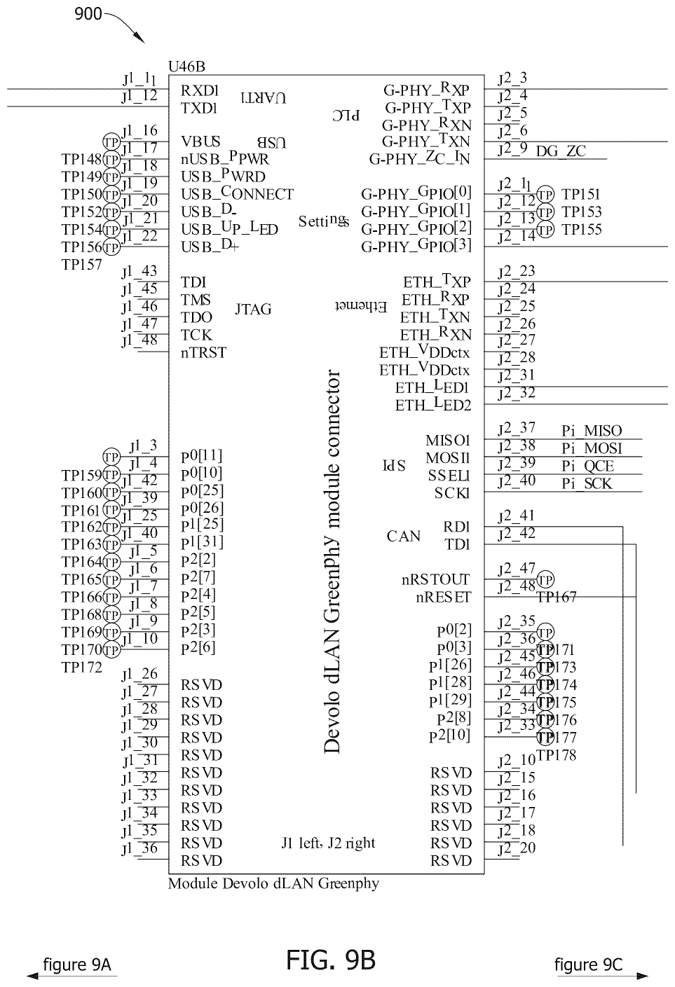

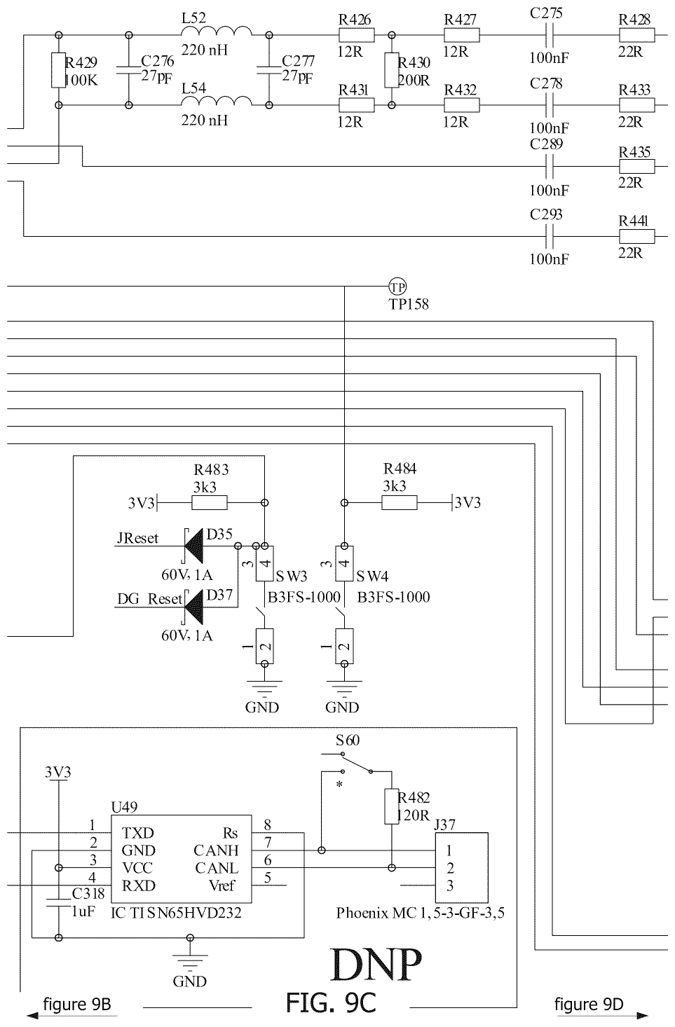

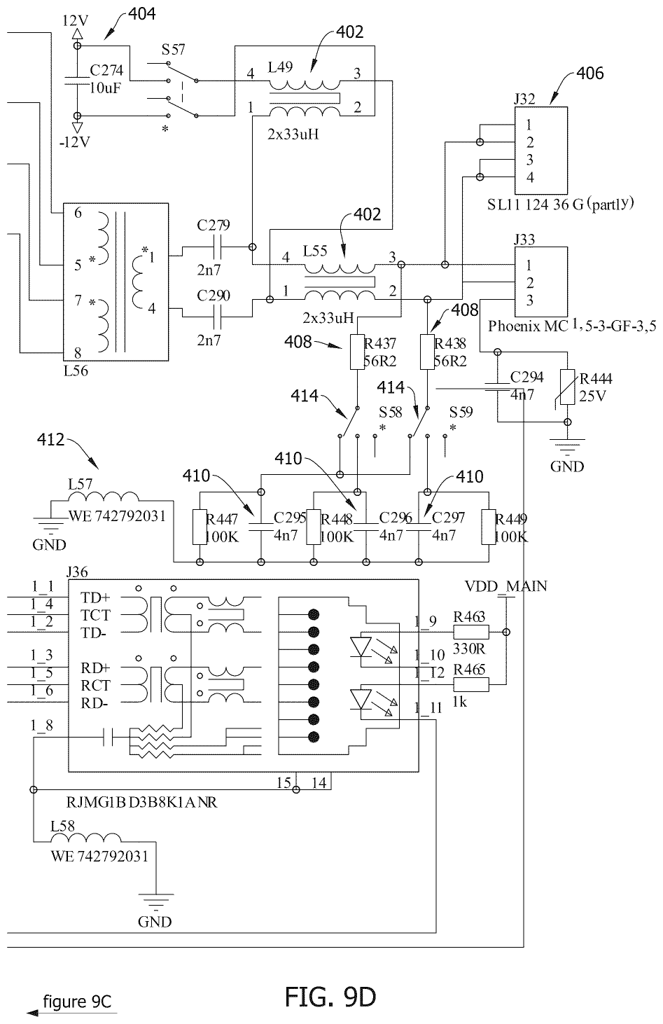

FIGS. 9A-9D depict a schematic diagram of another example circuit 900 for use in a differential PLC signaling configuration (e.g., between EVSE 102 and EV 104). Specifically, the embodiment shown in FIGS. 9A-9D utilizes a Devolo module. Circuit 900 includes common mode inductors 402, source 404, data lines 406, termination resistors 408, capacitors 410, inductor 412, and switches 414, which generally function as described with respect to FIGS. 4A and 4B.

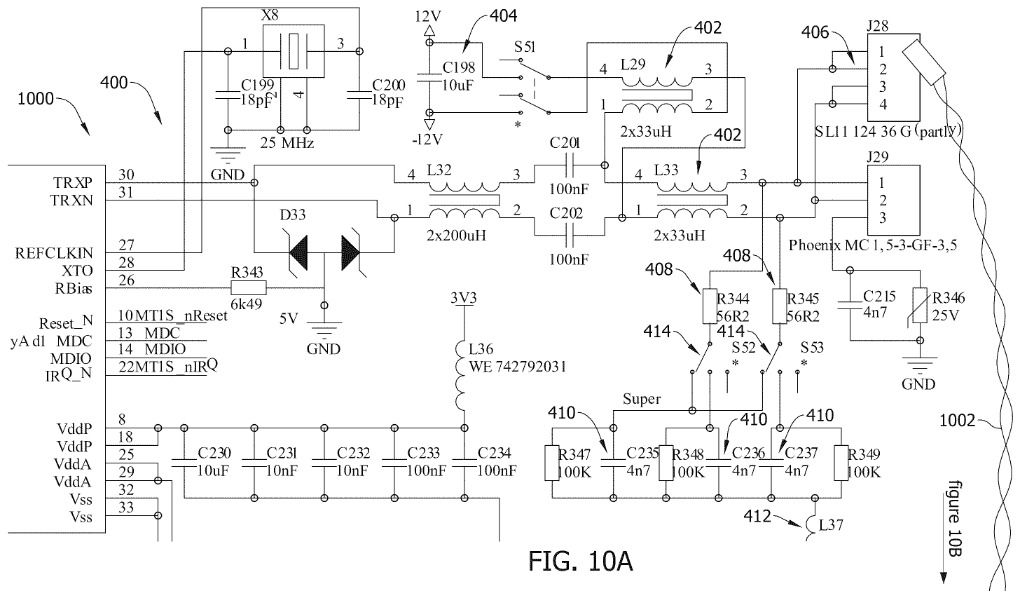

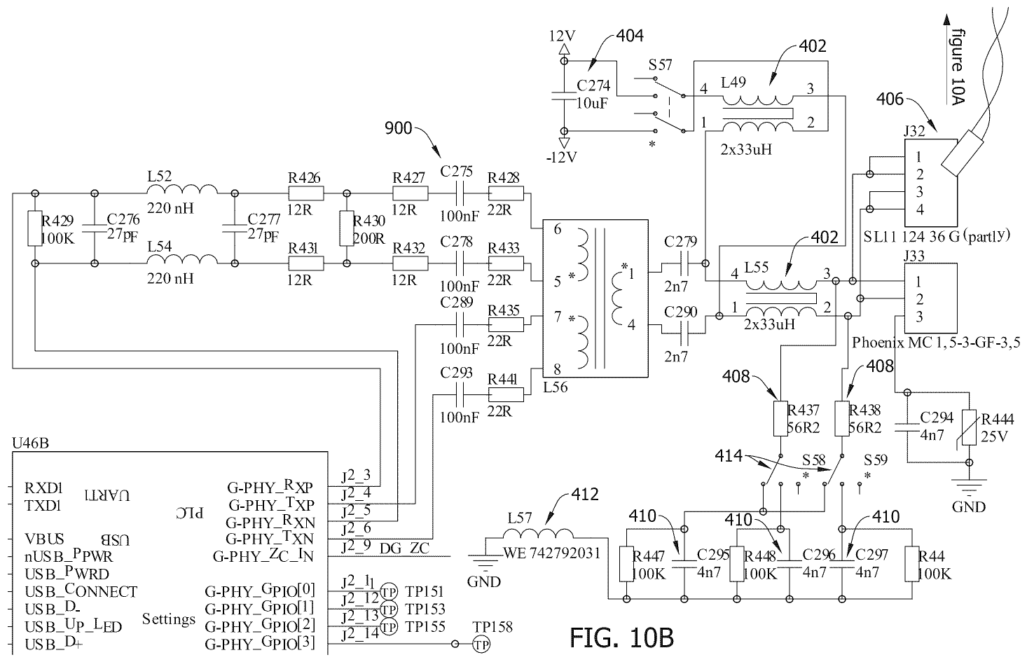

FIGS. 10A and 10B depict a schematic diagram of an example circuit 1000 utilizing a 10Base-TIS chip (such as circuit 400 shown in FIGS. 4A and 4B) and a PLC chip (such as circuit 900 shown in FIGS. 9A-9D) in parallel, with jumper wires 1002 coupling data lines 406 of the parallel chips, enabling the two chips to communicate with an external device using the same differential pair or pairs. Use of parallel chips, as illustrated with respect to circuit 1000, enables EVSE 102 to charge different EVs 104 that are configured to utilize different signaling protocols (e.g., Ethernet versus differential PLC) without needing relays or other switches to activate or deactivate respective chips.

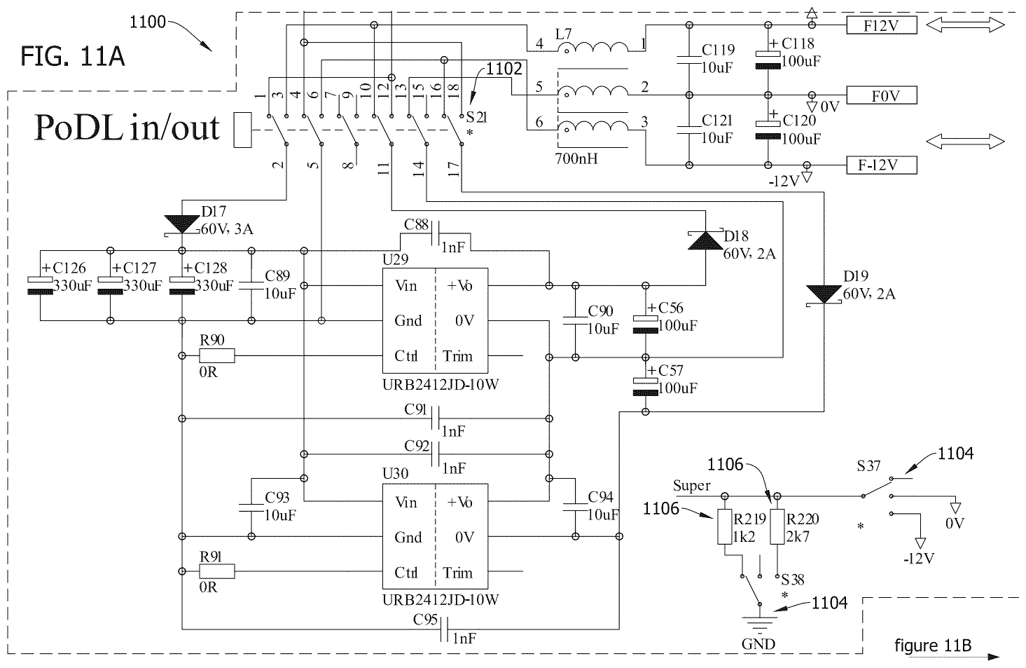

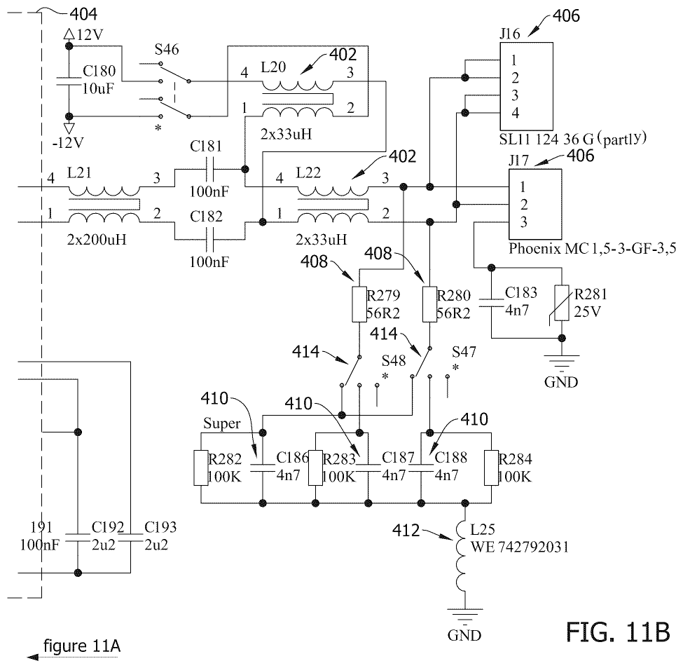

FIGS. 11A and 11B depict a schematic diagram of an example circuit 1100 for providing power over a data line. Circuit 1100 includes common mode inductors 402, source 404, data lines 406, termination resistors 408, capacitors 410, inductor 412, and switches 414, which generally function as described with respect to FIGS. 4A and 4B. FIGS. 11A and 11B further illustrate additional detail of source 404. Source 404 includes a switch 1102 for controlling or selecting a direction of the power over data line, or in other words, whether source 404 is to provide power or receive power through data lines 406. Source 404 further includes a pulldown switches 1104 for selecting one of pulldown resistors 1106 for using, for example, either-twelve volt or zero volt for superposition on power over data lines.

FIG. 12 depicts a schematic diagram of an example circuit 1200 for serving as an interface between EVSE 102 and EV 104. Circuit 1200 includes HLC lines 1202, which may be similar to data lines 406 described with respect to FIGS. 4A and 4B, FIGS. 5A-5C, FIGS. 6A-6E, FIGS. 7A-7D, FIGS. 8A-8F, FIGS. 9A-9D, FIGS. 10A and 10B, and FIGS. 11A and 11C. Circuit 1200 further includes LLC lines, in particular, an insertion detection (ID) line 1204 and a charge enable (CE) line 1206, which enable EV 104 to signal to EVSE 102 and EVSE 102 to signal to EVSE 102. Information conveyed using ID line 1204 and CE line 1206 may include information indicating a current state of the charging process and/or information to signal emergencies. In some embodiments, auxiliary power may be supplied over HLC lines 1202, ID line 1204, and/or CE line 1206, and/or superimposed signals may be transmitted over HLC lines 1202, ID line 1204, and/or CE line 1206.

FIGS. 13A-13J depict another schematic diagram of circuit 1200 illustrating additional detail of circuit 1200. FIGS. 13A-13J further illustrate various hardware implementations 1304 that enable circuit 1200 to interpret LLC signals (e.g., signals over ID line 1204 and/or CE line 1206) for hardware protection and/or detecting faults. For example, EVSE 102 may not provide power to EV 104 unless EVSE 102 and/or EV 104 determine that the LLC signals indicate a certain state. FIGS. 13A-13J also illustrates a testing circuit 1306 that enables circuit 1200 through various fault conditions that may be simulated by applying various inputs to testing circuit 1306.

FIGS. 14A and 14B depict a schematic diagram of an example circuit 1400 for providing an auxiliary power supply over an insertion detection line, such as that shown in FIG. 12. Circuit 1400 includes an e-fuse circuit 1402 that provides protection from short circuit conditions. E-fuse circuit 1402 also provides soft-start and inrush limit capabilities, and is automatically resettable. Circuit 1400 also includes a load switch circuit 1404 that is configured to supply auxiliary power (e.g., in blackout start situations) if an ID signal is at least a certain voltage threshold, such as seven volts, and disconnect auxiliary power if the insertion detection signal is less than the voltage threshold. Load switch circuit 1404 is configured to not significantly load the ID signal in situations where the ID signal is less than the voltage threshold. Accordingly, load switch circuit 1404 that allows for very low loading the ID signal when the voltage is below the (e.g., seven volt) threshold. E-fuse circuit 1402 may be implemented using an off-the-shelve product. Diodes 1406 isolate e-fuse circuit 1402 from ID signaling in case the auxiliary supply is not used.

FIG. 15 depicts a diagram of another example circuit 1500 for serving as an interface between EVSE 102 and EV 104 current level and/or voltage level signaling. Circuit 1500 includes a voltage supply 1502 and a current source 1504 on the EVSE-side, and a voltage clamp 1506, a current limiter 1508, and a resistor 1510 for current sensing and current limiting. In alternative implementations, voltage supply 1502 and current source 1504 may be disposed at EV 104, and voltage clamp 1506, current limiter 1508, and resistor 1510 may be disposed at EVSE 102.

Circuit 1500 enables data to be transmitted from EVSE 102 to EV 104 by controlling a current using current source 1504 and measuring a resulting current across resistor 1510. Such current signaling is inherently resistant to noise. Circuit 1500 further enables data to be transmitted from EV 104 to EVSE 102 by controlling a voltage of voltage clamp 1506, which can be measured by EVSE 102. By using a relatively wide voltage range (e.g., between two volts and eighteen volts) for transmitting from EV 104 to EVSE 102, the voltage signaling may also be made resistant to noise.

In some embodiments, circuit 1500 further includes a Zener diode 1512 coupled to the interface between EVSE 102 and EV 104. Zener diode 1512, when present (e.g., in an adapter or other component between EVSE 102 and EV 104) limits the voltage of the signal connecting EVSE 102 and EV 104. This can indicate to EVSE 102 and/or EV 104 that the adapter needs an auxiliary supply of power. For example, Zener diode 1512 may cause a specific, predefined voltage to be present, which, when detected by EVSE 102 and/or EV 104, causes EVSE 102 and/or EV 104 to supply auxiliary power to the adapter or other component. Also, in cases where the five volt supply at current limiter 1508 is not present, the voltage clamp 1506 cannot function due to the low current limitation. This allows EVSE 102 to detect the need for blackout-start on the EV-side if EV 104 is fitted with the correct Zener to signal blackout-start capability.

FIGS. 16A and 16B depict another schematic diagram of circuit 1500 illustrating additional detail of circuit 1500.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A communications interface between electric vehicle supply equipment and an electric vehicle, the communications interface comprising:
a first connection configured to connect to a controller of the electric vehicle supply equipment;
a second connection configured to connect to a controller of the electric vehicle; and
a plurality of communication conductors coupled between the first and second connections for communication between the controller of the electric vehicle supply equipment and the controller of the electric vehicle,
wherein the controller of the electric vehicle supply equipment is configured to supply power to the controller of the electric vehicle over one or more of the plurality of communication conductors.

2. The communication interface of claim 1, wherein:
the controller of the electric vehicle supply equipment comprises a plurality of physical layer (PHY) circuits each configured to communicate using a respective signaling format, and
the plurality of communication conductors are configured to convey communication signals generated by the plurality of PHY circuits.

3. The communication interface of claim 1, wherein:
the controller of the electric vehicle supply equipment is configured to supply direct current (DC) power to the controller of the electric vehicle over one or more of the plurality of communication conductors, and
the plurality of communication conductors are configured to convey a communication signal defined based on a center voltage of the DC power.

4. The communication interface of claim 1, wherein:
the controller of the electric vehicle supply equipment is configured to supply direct current (DC) power to the controller of the electric vehicle over one or more of the plurality of communication conductors, and
the plurality of communication conductors are configured to convey a communication signal defined based on a difference between a voltage of the communication signal and a center voltage of the DC power.

5. The communication interface of claim 1, wherein:
the controller of the electric vehicle is configured to supply power to the controller of the electric vehicle supply equipment over one or more of the plurality of communication conductors.

6. The communication interface of claim 1, wherein:
the controller of the electric vehicle supply equipment is configured to transmit a first communication signal to the electric vehicle using a current signaling protocol.

7. The communication interface of claim 6, wherein:
the controller of the electric vehicle supply equipment is configured to transmit a second communication signal to the electric vehicle using a voltage signaling protocol.

8. The communication interface of claim 1, wherein:
the one or more of the plurality of communication conductors includes an insertion detection (ID) line.

9. The communication interface of claim 1, wherein:
the one or more of the plurality of communication conductors includes a charge enable (CE) line.

10. A communications interface between electric vehicle supply equipment and an electric vehicle, the communications interface comprising:
a first connection configured to connect to a controller of the electric vehicle supply equipment;
a second connection configured to connect to a controller of the electric vehicle; and
a plurality of communication conductors coupled between the first and second connections for communication between the controller of the electric vehicle supply equipment and the controller of the electric vehicle,
wherein the controller of the electric vehicle is configured to supply power to the controller of the electric vehicle supply equipment over one or more of the plurality of communication conductors.

11. The communication interface of claim 10, wherein:
the controller of the electric vehicle comprises a plurality of physical layer (PHY) circuits each configured to communicate using a respective signaling format, and
the plurality of communication conductors are configured to convey communication signals generated by the plurality of PHY circuits.

12. The communication interface of claim 10, wherein:
the controller of the electric vehicle is configured to supply direct current (DC) power to the controller of the electric vehicle supply equipment over one or more of the plurality of communication conductors, and
the plurality of communication conductors are configured to convey a communication signal defined based on a center voltage of the DC power.

13. The communication interface of claim 10, wherein:
the controller of the electric vehicle is configured to supply direct current (DC) power to the controller of the electric vehicle supply equipment over one or more of the plurality of communication conductors, and
the plurality of communication conductors are configured to convey a communication signal defined based on a difference between a voltage of the communication signal and a center voltage of the DC power.

14. The communication interface of claim 10, wherein:
the controller of the electric vehicle supply equipment is configured to supply power to the controller of the electric vehicle over one or more of the plurality of communication conductors.

15. The communication interface of claim 10, wherein:
the controller of the electric vehicle is configured to transmit a first communication signal to the electric vehicle supply equipment using a current signaling protocol.

16. The communication interface of claim 15, wherein:
the controller of the electric vehicle is configured to transmit a second communication signal to the electric vehicle supply equipment using a voltage signaling protocol.

17. The communication interface of claim 10, wherein:
the one or more of the plurality of communication conductors includes an insertion detection (ID) line.

18. The communication interface of claim 10, wherein:
the one or more of the plurality of communication conductors includes a charge enable (CE) line.

19. A circuit for providing an auxiliary power supply over an insertion detection (ID) line, the circuit comprising;
an e-fuse; and
a load switch circuit coupled to the e-fuse and to the ID line, the load switch circuit configured to supply auxiliary power via the ID line when an ID signal received via the ID line is at least a threshold voltage.

20. The circuit of claim 19, wherein:
the load switch circuit is further configured to disconnect the auxiliary power when the ID signal received via the ID line is less than the threshold voltage.
